(19) United States
(12) Patent Application Publication
(10) Pub. No.: US 2026/0310015 A1
(43) Pub. Date: Oct. 8, 2026

(54) TUNABLE ON-CHIP VARIABLE RATIO OPTICAL COUPLER COMPRISING PHASE CHANGE MATERIAL

(71) Applicant: CORNING INCORPORATED, CORNING, NY (US)

(72) Inventors: Lars Martin Otfried Brusberg, Potsdam (DE); Paulo Clovis Dainese, Jr., Painted Post, NY (US); Aramais Robert Zakharian, Painted Post, NY (US); Beibei Zeng, Pleasanton, CA (US)

(21) Appl. No.: 19/480,952

(22) PCT Filed: May 21, 2024
(86) PCT No.: PCT/US2024/030296

§ 371 Date: Nov. 3, 2025

Related U.S. Application Data
(60) Provisional application No. 63/468,386, filed on May 23, 2023.

(51) Int. Cl. G02F 1/035

(52) U.S. Cl. CPC G02F 1/035

(57) ABSTRACT

A variable ratio optical coupler includes a plurality of waveguides arranged in or on a primary substrate, including waveguides arranged proximate to one another in at least one coupling region and configured for optical power transfer by evanescent coupling, with a phase change material (PCM) arranged over a waveguide in the at least one coupling region, and electrode segments arranged over the PCM at overlap regions. Individual electrode segments are configured to receive electrical pulses to heat the electrode segment to permit non-volatile adjustment of a degree of transition between a crystalline state and an amorphous state of the PCM at the corresponding overlap region, thereby adjusting optical properties thereof and affecting optical power transfer between adjacent waveguides. A kit includes the variable ratio optical coupler and a tuning device configured to deliver electrical pulses to at least one electrode segment to permit the above-mentioned state adjustment.

### CROSS-REFERENCE TO RELATED APPLICATIONS

This application claims the benefit of priority under 35 U.S.C. § 119 of U.S. Provisional Application No. 63/468,386 filed May 23, 2023, the content of which is incorporated herein by reference in its entirety.

### BACKGROUND

The disclosure relates generally to optical couplers for conveying optical signals between waveguides arranged in or on substrates, including but not limited to substrates of including photonic integrated circuits.

Photonic systems are based on the generation, manipulation, and/or detection of light much in the way that electronic systems are based on the generation, manipulation, and/or detection of electricity. Systems that are based on the generation, manipulation, and/or detection of both light and electricity are sometimes referred to as opto-electronic systems.

For high-speed, off-chip interconnects, co-packaging of optical transceivers with items such as electrical integrated circuits (ICs) or switching application specific integrated circuits (ASICs) has been proposed to reduce the length of electrical interconnects for high frequency (e.g., 56 Gb/s and higher) electrical signal links. This is beneficial due to the high loss and increased power consumption of electrical signals at higher frequencies.

As the demand for high-density parallel data transmission increases, a dense layout of embedded optical waveguide channels is desirable. Additionally, for certain applications it may be desirable to couple optical signals between photonic integrated circuits (PICs) and waveguides on a packaging substrate. A PIC is a device that integrates multiple (i.e., at least two) photonic functions. Functional devices that may be integrated in a PIC include low loss interconnect waveguides, power splitters, optical amplifiers, optical modulators, multiplexers/demultiplexers, filters, lasers, and detectors.

The expansion of new broadband access networks has been increasing in recent decades, driven by a steady growth of multimedia streaming services, online gaming, and high-definition television over the Internet. In order to meet increased bandwidth requirements, optical fiber-based access networks have been widely investigated and deployed. Passive Optical Network (PON) architecture has been identified as the most promising broadband access solution due to wide bandwidth, low-cost deployment, and relatively low-cost maintenance. Primary topologies for PON include centralized split, distributed (symmetric) split, and asymmetric distributed split, with the latter topology generally entailing lower cost. Components and systems for PON architecture are being developed for delivery to outside-plant fiber optic cable customers, wherein “outside-plant” generally refers to equipment, cables and infrastructure that are located outside of a building. In this context, configurable optical components such as optical splitters with tunable splitting ratio (referred to as Variable Ratio Couplers or VRCs) are key building blocks for the asymmetric distributed split architecture and (more generally) for future reconfigurable optical networks.

Conventional optical splitters providing variable ratio coupling utility typically employ fused biconic tapered (FBT) optical fibers or multi-clad (MC) optical fiber couplers, which may have fixed or tunable splitting ratios. Conventional FBT and MC fiber couplers with fixed splitting ratios limit network configurability, as they entail inefficient distribution of optical power for both time division multiplexing and point-to-point wavelength division multiplexing channels, due to granular insertion losses. Variable MC coupler technology has been applied to 1×2 fiber optic splitters with variable power splitting ratios over a broad bandwidth. However, such couplers require either an expensive high-precision integral micrometer or a low-precision screw gauge to effectuate mechanical bending of the MC-fiber coupler, leading to bulky devices with reliability, scalability and cost issues. Moreover, bending can induce coupling between the fundamental and high-order modes, resulting in oscillatory behavior of the output power.

With the development of micro/nano-fabrication technology in recent decades, on-chip integrated photonic devices, such as micro-ring resonators, ultracompact optical couplers and switches, Mach-Zehnder interferometers and modulators, provide more possibilities in terms of compact size, scalability, functionality, reliability, and cost. Programmable photonics is an emerging field of research seeking to allow reconfiguration of the functions of integrated photonic components by programmably changing local optical properties within a waveguide. However, various actively tunable photonic couplers based on electro-optic and thermo-optic effects utilize moving parts and/or require a continuous supply of power to maintain a tuned status once configuration is complete. Such considerations increase complexity and limit reliability of large-scale networks utilizing a multitude of photonic couplers. Need therefore exists in the art for improved photonic couplers that address limitations associated with conventional devices.

### SUMMARY

A variable ratio optical coupler according to various aspects includes a plurality of waveguides arranged in or on substrate, including waveguides arranged proximate to one another in at least one coupling region and configured for optical power transfer by evanescent coupling, with a phase change material (PCM) (embodied in a continuous segment in certain embodiments) arranged over a waveguide in the at least one coupling region. A plurality of electrode segments arranged over the PCM at a plurality of overlap regions, wherein individual electrode segments are configured to receive electrical pulses to heat the electrode segment to permit adjustment of a degree of transition between a crystalline state and an amorphous state of the PCM at the corresponding overlap region, thereby adjusting optical properties thereof and affecting optical power transfer between adjacent waveguides. The state (or phase) transition of the PCM generates strong optical modulation with a large refractive index change (e.g., greater than 1), permitting optical properties to be adjusted in a compact footprint with a full range tunability (e.g., tunable splitting ratio) from 0 to 100% in certain embodiments, combined with low insertion loss. Unlike active optical devices based on electro-optic and thermo-optic effects, the phase change phenomenon of PCM is non-volatile, enabling self-holding or latching capability to maintain configured optical states with zero static energy consumption (i.e., avoiding the need for continuous power input). Once a suitable PCM has undergone a transition, the optical characteristics are retained until a further tuning is performed. Waveguides may be formed below an outer face of a substrate by methods such as ion-diffusion, by laser writing, or a combination thereof, or waveguides may be raised relative to an outer face of a substrate by photolithographic or e-beam patterning and etching, thin-film deposition, lamination, deposition, or other fabrication (including microfabrication or nanofabrication) techniques. 1×2, 1×4, and 2×2 variable ratio optical couplers are provided in certain embodiments. One or more variable ratio optical couplers may be combined in a single device, optionally embodied in a photonic integrated circuit device.

In one aspect, the disclosure relates to a variable ratio optical coupler that comprises: first and second waveguides arranged in or on a primary substrate, wherein a portion of the first waveguide and a portion of the second waveguide are arranged proximate to one another in at least one coupling region and configured for optical power transfer by evanescent coupling; a continuous phase change material segment arranged over the portion of the first waveguide in the at least one coupling region; and a plurality of electrode segments sequentially arranged over the continuous phase change material segment at a plurality of overlap regions. Each electrode segment of the plurality of electrode segments is arranged over a corresponding overlap region of the plurality of overlap regions, and each electrode segment is arranged to receive electrical pulses configured to heat the electrode segment to permit adjustment of a degree of transition between a crystalline state and an amorphous state of phase change material of the continuous phase change material segment at the corresponding overlap region.

In certain embodiments, the variable ratio optical coupler further comprises a plurality of electrically conductive traces deposited on the primary substrate and conductively coupled with the plurality of electrode segments.

In certain embodiments, the primary substrate comprises a glass or glass-based material, and each of the first waveguide and the second waveguide comprises an ion exchanged (IOX) waveguide arranged in the primary substrate.

In certain embodiments, the primary substrate comprises any of: a silicon nitride substrate, a silicon-on-insulator substrate, and a planar lightwave circuit substrate.

In certain embodiments, the continuous phase change material segment comprises Ge₂Sb₂Se₄Te₁ (GSST).

In certain embodiments, the continuous phase change material segment comprises a first end with a tapered width and comprises a second end with a tapered width.

In certain embodiments, the variable ratio optical coupler further comprises a secondary substrate arranged over the plurality of electrode segments, the continuous phase change material segment, the first and second waveguides, and the primary substrate, wherein the secondary substrate comprises a lower index of refraction than an index of refraction of the primary substrate.

In certain embodiments, the at least one coupling region comprises a plurality of coupling regions, wherein the first waveguide and the second waveguide diverge from and reconverge toward one another between pairs of coupling regions of the plurality of coupling regions.

In certain embodiments, the variable ratio optical coupler further comprises a third waveguide arranged on or in the primary substrate, wherein a portion of the third waveguide is arranged proximate to the first waveguide in the at least one coupling region and configured for optical power transfer by evanescent coupling, and wherein the portion of the first waveguide is intermediately arranged between the portion of the second waveguide and the portion of the third waveguide in the at least one coupling region.

In certain embodiments, the first, second, and third waveguides are formed in the primary substrate, and wherein the first waveguide is positioned at a shallower depth than the second and third waveguides relative to an upper surface of the primary substrate.

In certain embodiments, the variable ratio optical ratio coupler has an insertion loss of less than 2 dB, less than 1 dB, or less than 0.5 dB, or less than 0.2 dB.

In certain embodiments, the variable ratio optical ratio coupler has largest dimensions of no greater than 20 mm×10 mm×2 mm.

In certain embodiments, after a desired degree of transition between a crystalline state and an amorphous state of phase change material of the variable ratio optical coupler is attained, the degree of transition of state of the phase change material is maintained with zero static power input.

In certain embodiments, the disclosure relates to a kit comprising the variable ratio optical coupler as disclosed herein and a tuning device comprising a circuit configured to deliver electrical pulses to at least one electrode segment of the plurality of electrode segments to heat the at least one electrode segment to permit adjustment of a degree of transition between a crystalline state and an amorphous state of the phase change material.

In another aspect, the disclosure relates to a variable ratio optical coupler comprising: a plurality of waveguides including first, second, and third waveguides arranged in or on a primary substrate, wherein a portion of the second waveguide is arranged proximate to the first waveguide at a first coupling region, and a portion of the third waveguide is arranged proximate to the first waveguide at a second coupling region; phase change material arranged over the first waveguide at the first coupling region and arranged over the first waveguide at the second coupling region; a first electrode segment arranged over the phase change material at a first overlap region overlying the first coupling region, the first electrode segment being arranged to receive an electrical signal configured to heat the first electrode segment to permit adjustment of a degree of transition between a crystalline state and an amorphous state of the phase change material at the first coupling region; and a second electrode segment arranged over the phase change material at a second overlap region overlying the second coupling region, the second electrode segment being arranged to receive an electrical signal configured to heat the second electrode segment to permit adjustment of a degree of transition between a crystalline state and an amorphous state of the phase change material at the second coupling region.

In certain embodiments, the phase change material is arranged in a continuous phase change material segment extending across and between the first coupling region and the second coupling region.

In certain embodiments, the phase change material is discontinuous between the first coupling region and the second coupling region.

In certain embodiments, the variable ratio optical ratio coupler further comprises a fourth waveguide arranged in or on the primary substrate, wherein a portion of the fourth waveguide is arranged proximate to the first waveguide at a third coupling region; wherein phase change material is arranged over the first waveguide at the third coupling region; and wherein the variable ratio optical coupler further comprises a third electrode segment arranged over the phase change material at a third overlap region overlying the third coupling region, the third electrode segment being arranged to receive an electrical signal configured to heat the third electrode segment to permit adjustment of a degree of transition between a crystalline state and an amorphous state of the phase change material at the third coupling region.

In certain embodiments, the variable ratio optical coupler further comprises a plurality of electrically conductive traces deposited on the substrate and conductively coupled with the first electrode segment and the second electrode segment.

In certain embodiments, the primary substrate comprises a glass or glass-based material, and each waveguide of the plurality of waveguides comprises an ion exchange (IOX) waveguide arranged in the primary substrate.

In certain embodiments, the primary substrate comprises any of: a silicon nitride substrate, a silicon-on-insulator substrate, and a planar lightwave circuit substrate.

In certain embodiments, the variable ratio optical coupler further comprises a secondary substrate arranged over the plurality of electrode segments, the phase change material, the first and second waveguides, and the primary substrate, wherein the secondary substrate comprises a lower index of refraction than an index of refraction of the primary substrate.

In certain embodiments, the variable ratio optical coupler has an insertion loss of less than 2 dB, less than 1 dB, or less than 0.5 dB, or less than 0.2 dB.

In certain embodiments, the variable ratio optical coupler has largest dimensions of no greater than 20 mm×10 mm×2 mm.

In certain embodiments, after a desired degree of transition between a crystalline state and an amorphous state of phase change material is attained, the degree of transition of state of the phase change material of the variable ratio optical coupler is maintained with zero static power input.

In certain embodiments, the disclosure relates to a kit comprising a variable ratio optical coupler as disclosed herein and a tuning device comprising a circuit configured to deliver electrical pulses to at least one electrode segment of the first electrode segment and the second electrode segment to heat the at least one electrode segment to permit adjustment of a degree of transition between a crystalline state and an amorphous state of the phase change material.

In another aspect, features of any aspects or embodiments disclosed herein may be combined for additional advantage.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a perspective view of a waveguide assembly formed from a glass substrate with multiple glass optical waveguides defined along an upper surface thereof.

FIG. 1B is a perspective view of the waveguide assembly of FIG. 1A following addition of a protective coating over the upper surface of the glass substrate.

FIG. 2A is a magnified side (x-z) cross-sectional view of a peripheral portion of a waveguide assembly showing a glass optical waveguide defined along an upper surface of a glass substrate, with the glass optical waveguide terminating prior to reaching an edge of the substrate.

FIG. 2B is a magnified side (y-z) cross-sectional view of the waveguide assembly of FIG. 2A showing glass optical waveguides defined along the upper surface of the glass substrate.

FIG. 2C is a perspective view of a waveguide assembly similar to the waveguide assembly shown in FIGS. 2A-2B, but with glass optical waveguides extending to edges of the glass substrate.

FIG. 3 is a schematic diagram of a laser-based optical processing system for processing a glass substrate to form glass optical waveguides proximate to or along an upper surface thereof.

FIGS. 4A-4D are perspective views of a variable ratio optical coupler according to one embodiment in four states of fabrication, the variable ratio optical coupler including first and second waveguides arranged in a primary substrate (shown in FIG. 4A), with a continuous phase change material (PCM) segment arranged over a portion of one waveguide (shown in FIG. 4B), with a plurality of electrode segments sequentially arranged over the continuous PCM segment (shown in FIG. 4C), and with a secondary substrate arranged over the foregoing items (shown in FIG. 4D).

FIG. 5 is a perspective view schematic diagram of first and second waveguide portions of a variable ratio optical coupler according to one embodiment, with a PCM segment and corresponding first through fifth electrodes arranged over one waveguide that is arranged proximate to, and optically coupled to, another waveguide.

FIGS. 6A-6C are modeled field distribution diagrams for a two-waveguide 1×2 variable ratio optical coupler corresponding generally to the configuration shown in FIG. 5 with different proportions of Ge₂Sb₂Se₄Te₁ (GSST) phase change material in an amorphous versus crystalline state following application of electrical pulses to different combinations of the first through fifth electrodes, with FIG. 6A representing a 25 μm length of GSST in an amorphous state, with FIG. 6B representing a 15 μm length of GSST in an amorphous state, and with FIG. 6C representing a 5 μm length of GSST in an amorphous state.

FIG. 7 is a plot of calculated transmission spectrum (transmittance versus wavelength) of a one tap output of a GSST-covered waveguide according to FIGS. 6A-6C with five overlap regions (e.g., shown in FIG. 5) when the amorphous GSST sections decrease in aggregate length from 25 μm to 5 μm, and concomitantly when the crystalline GSST increase in aggregate length from 0 μm to 20 μm in 5 μm steps.

FIGS. 8A and 8B are modeled field distribution diagrams for a two-waveguide 1×2 variable ratio optical coupler corresponding generally to the configuration shown in FIG. 5 with different gap distances between the two waveguides, namely, a gap distance of 150 nm in FIG. 8A and a gap distance of 250 nm in FIG. 8B.

FIG. 9 is a plot of calculated transmission spectrum (transmittance versus wavelength) of a tap output of the GSST-covered waveguide according to FIGS. 8A-8B when the coupling length degreases from 25 μm (at top) to 10 μm (at bottom) in steps of 2 μm or 3 μm.

FIGS. 10A and 10B are modeled field distribution diagrams for a two-waveguide 1×2 variable ratio optical coupler corresponding generally to the configuration shown in FIG. 5 with different coupling lengths between the two waveguides, namely, a coupling length of 25 μm in FIG. 10A and a coupling length of 10 μm in FIG. 10B.

FIG. 11 is a plot of calculated transmission spectrum (transmittance versus wavelength) of a tap output of the GSST-covered waveguide according to FIGS. 10A-10B when the coupling length degreases from 25 μm (at top) to 10 μm (at bottom) in steps of 2 μm or 3 μm.

FIG. 12 is a cross-sectional view of a portion of a variable ratio optical coupler according to one embodiment including first and second waveguides that are arranged on (i.e., raised relative to) a primary substrate, with a PCM segment arranged over one waveguide and an electrode arranged over the PCM segment.

FIGS. 13A-13D are perspective views of a 1×2 variable ratio optical coupler according to one embodiment in four states of fabrication, the variable ratio optical coupler including first and second waveguides arranged on a primary substrate (shown in FIG. 13A), with a continuous phase change material (PCM) segment arranged over a portion of one waveguide (shown in FIG. 13B), with a plurality of electrode segments sequentially arranged over the continuous PCM segment (shown in FIG. 13C), and with a secondary substrate arranged over the foregoing items (shown in FIG. 13D).

FIGS. 14A-14E are top plan views of PCM segments having end portions with tapered or reduced widths according to certain embodiments.

FIG. 15 is a schematic top view of a variable ratio optical coupler providing two outputs according to one embodiment including two waveguides and three coupling regions each having an electrode arranged over a continuous PCM segment overlying portions of one waveguide, wherein the waveguides diverge from and reconverge toward one another between pairs of coupling regions.

FIG. 16A is a schematic top view of a 1×4 variable ratio optical coupler providing four outputs according to one embodiment including four waveguides and three coupling regions each having an electrode arranged over a continuous PCM segment overlying portions of a different waveguide, with designed power coupling or splitting ratios at each coupling region provided by the electrodes and PCM.

FIG. 16B is a schematic top view of a 1×4 variable ratio optical coupler providing four outputs according to one embodiment including four waveguides and three coupling regions each having an electrode arranged over a separate PCM region (i.e., providing discontinuous PCM regions) overlying portions of a different waveguide, with designed power coupling or splitting ratios at each coupling region provided by the electrodes and PCM.

FIG. 17 is a transverse cross-sectional view of a 1×2 variable ratio optical coupler including two ion exchanged (IOX) waveguides arranged in a substrate with PCM material arranged over one waveguide.

FIG. 18 is a plot of optical coupling efficiency at 1550 nm wavelength versus coupler length, computed for a variable ratio optical coupler according to FIG. 17.

FIG. 19 is a plot of optical coupling efficiency versus wavelength computed for a variable ratio optical coupler according to FIG. 17 having about a 4 mm coupling length.

FIGS. 20A and 20B are perspective views of a 2×2 variable ratio optical coupler according to one embodiment in two states of fabrication, the variable ratio optical coupler including first through third waveguides arranged in a primary substrate with a continuous phase change material (PCM) segment arranged over a center waveguide (shown in FIG. 20A), and with a plurality of electrode segments sequentially arranged over the continuous PCM segment (shown in FIG. 20B).

FIG. 21 is a transverse cross-sectional view of a 2×2 variable ratio optical coupler including three ion exchanged (IOX) waveguides arranged in a substrate with PCM material arranged over a center waveguide, with the center waveguide being configured as a surface waveguide and the surrounding waveguides being configured as buried waveguides.

FIG. 22 is a plot of optical coupling efficiency at 1550 nm wavelength versus coupler length, computed for a variable ratio optical coupler according to FIG. 21.

FIG. 23 is a plot of optical coupling efficiency versus wavelength computed for a variable ratio optical coupler according to FIG. 21 having a 14 mm coupling length.

FIG. 24 is a circuit diagram for a tuning circuit configured to deliver electrical pulses to at least one electrode segment of a variable ratio optical coupler as disclosed herein to heat the at least one electrode segment to permit adjustment of a degree of transition between a crystalline state and an amorphous state of phase change material.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Identification of a first element and a second element in the specification in the drawings does not preclude the same items as being identified as a second element and a first element, respectively, in the claims. As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As introduced previously, a variable ratio optical coupler according to certain aspects includes a plurality of waveguides arranged in or on substrate, with waveguides arranged proximate to one another in at least one coupling region and configured for optical power transfer by evanescent coupling, wherein a phase change material (PCM) (embodied in a continuous segment in certain embodiments) is arranged over a waveguide in the at least one coupling region, and a plurality of electrode segments arranged over the PCM at a plurality of overlap regions.

Before variable ratio optical couplers and their fabrication, the formation of glass optical wavelengths in or on substrates (e.g., glass substrates) will be introduced.

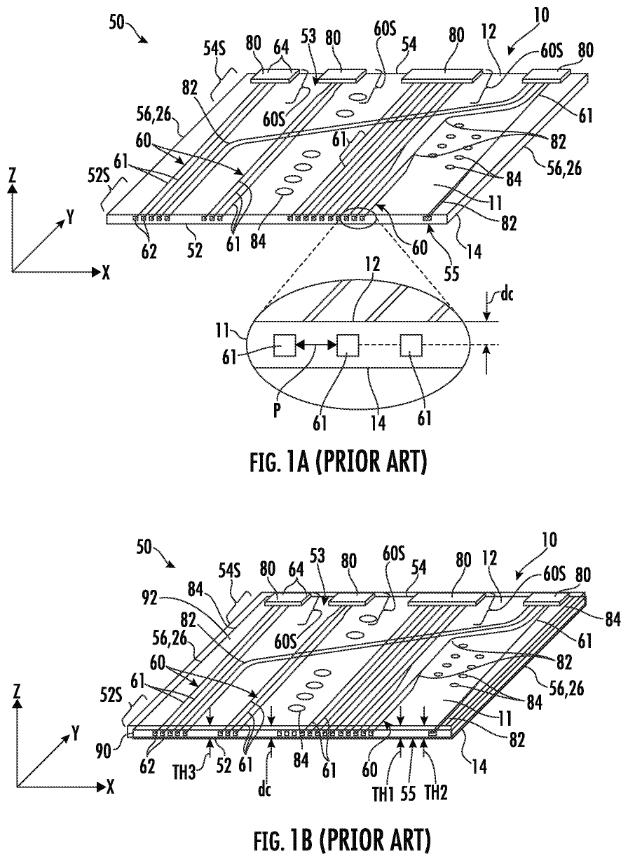

FIG. 1A is a perspective view of a glass waveguide assembly 50 formed from a glass or glass-based, substrate 10 with multiple glass optical waveguides (“waveguides”) 61 defined with the glass substrate 10 (e.g., proximate to a top surface 12 thereof). It is to be appreciated that other substrate materials may be used, as described hereinafter. FIG. 1B is a perspective view of the waveguide assembly 50 of FIG. 1A following addition of a protective coating 90 over the top surface 12 of the glass substrate 10. The glass waveguide assembly 50 has a front end 52, a rear end 54, and sides 56 that respectively correspond to boundaries of the glass substrate 10. The glass waveguide assembly 50 also includes a top side 53 and a bottom side 55. The glass waveguide assembly 50 also includes a front-end assembly section 52S having the front end 52, and a rear-end assembly section 54S having the back end 54.

With reference to FIGS. 1A and 1B, the glass waveguide assembly 50 includes waveguides 61, which can define a waveguide array 60. Reference may be made herein to multiple waveguides 61 as well as to one or more waveguide arrays 60 by way of illustration.

The waveguides 61 are formed within a body 11 of the glass substrate 10 and run generally in the y-direction from (at or near) the front end 52 to (at or near) the rear end 54 of the glass substrate 10. Each waveguide 61 includes a front waveguide end 62 at or adjacent to the front end 52 of glass substrate 10 and a rear end 64 at or near the rear end 54 of the glass substrate 10. The waveguide array 60 includes a rear-end section 60S that includes waveguide rear ends 64. The waveguides 61 can also run from the front end 52 of the glass substrate 10 or from the rear end 54 of the glass substrate 10 to one of sides 56 of the glass substrate 10, e.g., by a combination of straight and/or curved waveguide sections 82.

The waveguides 61 are formed from glass, and in certain examples may be formed within a glass material of the body 11 by modifying the glass composition. In certain examples, this compositional modification may be accomplished by ion diffusion, by laser writing, or by a combination thereof. Thus, in certain examples, waveguides 61 may be formed within the body 11 of the glass substrate 10 without removing any glass from the body 11 or adding any glass to the body 11. In this context, it is noted that ion-diffusion does not result in the removal of glass or the addition of glass, but instead alters the composition of the glass by replacing existing mobile alkali ions in the glass with other alkali ions (e.g., replacing Na+ with K+) from an outside source, such as a molten bath. Likewise, laser writing does not remove any glass from the body 11 or add glass thereto, but instead locally alters the structure of the glass by locally compacting it, which in turn locally increases the refractive index.

In an example, the glass substrate 10 is made of ion-exchangeable glass, i.e., one that contains alkali ions such as Na⁺. An example material for glass substrate 10 is a chemically strengthened glass or a glass suitable for chemical strengthening. An example of such a glass is Gorilla® glass, available from Corning, Inc., Corning, New York. In an example, glass substrate 10 is made of a Ag+ion-exchanged glass, e.g., where Ag⁺ has been exchanged for Na⁺ in the glass substrate. An ion exchange process for defining waveguides may include a single-or multi-step thermal or field-assisted ion-exchange with or without use of a mask layer for defining the waveguide layout. If desired, a waveguide layout may be defined by a mask layer formed on the top surface 12 of the glass substrate 10 prior to the ion-exchange. Waveguide layouts can be defined through the position of a focused laser by sequential laser writing. The resulting waveguides can be straight waveguides, curved waveguides, etc., and can include optical features or components such as tapers, crossings, splitters, combiners, and arcs, which may be combinable in fan-out or fan-in arrays in certain embodiments.

The depth dC to which waveguides 61 reside relative to the top surface 12 (or to a bottom surface 14) of the glass substrate 10 can vary, with reference to the magnified inset portion of FIG. 1A). Likewise, the pitch p of a waveguide array 60 can vary with position, and in particular can vary in the y-direction as well as in the z-direction (e.g., in instances case where the body 11 supports different rows of waveguides 61 at different depths within body 11). Each waveguide 61 can include a tapered section and can also vary in size along its length. The path of each waveguide 61 can also vary, i.e., it need not run in a straight line, and as noted above need not run in a given x-y plane. The waveguides 61 can be single mode or multimode. In certain examples, the rear waveguide ends 64 may define respective optical quality end faces, which in an example can be formed by polishing (e.g., laser polishing or mechanical polishing) or score and break (e.g., diamond wheel scoring or laser scoring and separation).

The glass waveguide assembly 50 also includes at least one waveguide termination member (“connector”) 80 that terminates at least one waveguide 61 (e.g., at or adjacent to the rear waveguide end 64) at connector region(s) 15. In an example, a single connector 80 may embody a multi-waveguide connector (e.g., a MT type or MPO type connector) that terminates multiple waveguides 61. In an example, each connector 80 may terminate a corresponding array 60 of one or more waveguides 61. In another example, at least one connector 80 may include waveguides 61 from different waveguide arrays 60. In an example, connector 80 encloses the rear-end array section 60S of waveguide array 60 at a connector region 15.

The glass waveguide assembly 50 can also include one or more OE-PCB features or components 84 to facilitate the use of the glass waveguide assembly 50 in forming an OE-PCB, as described below. Exemplary OE-PCB features or components 84 include conducting (e.g., metal-filled) vias, insulating (e.g., polymer-filled) vias, electrical (conducting) contacts, electrical (conducting) wiring, optical vias, slots, cut-outs, polymer-filled cut-outs, open holes, perforations, fiducials, alignment features, etc. In an example, OE-PCB features or components 84 may be formed by drilling, etching, milling, depositing, laser ablation, etc. In particular, cut-outs are relatively large sections removed from glass substrate 10 and that can be used for mounting glass waveguide assembly 50 to a PCB or OE-PCB. If desired, cut-outs can be filled with a non-glass material (e.g., a polymer), some or all of which can be removed later on in the OE-PCB fabrication process. The OE-PCB features or components 84 for alignment are formed where needed to allow for a simple passive alignment process for connectors 80 and for other photonic devices of an OE-PCB. The integration of glass waveguide assemblies into optical-electronic printed circuit boards (OE-PCBs) is disclosed in International Patent Application Publication No. WO 2018/144199 A1 of Corning Optical Communications LLC, wherein the entire contents of the foregoing publication are hereby incorporated by reference herein.

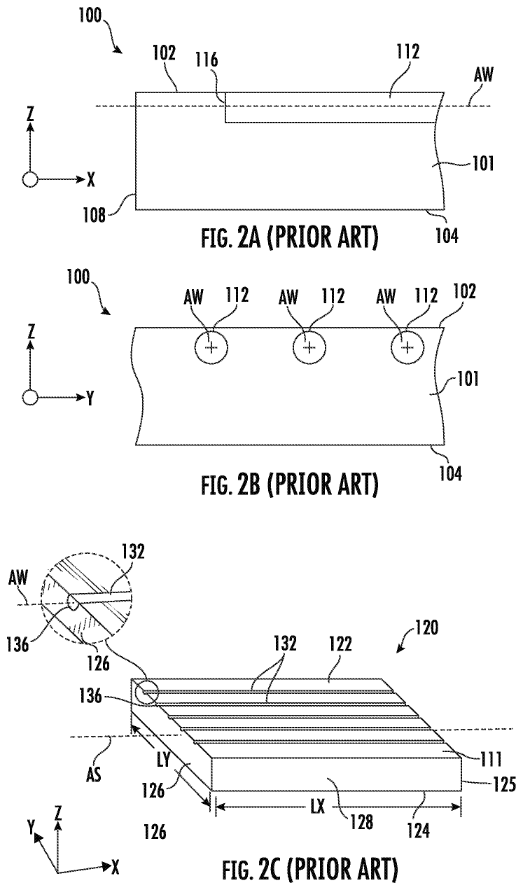

With reference to FIG. 2B, the glass waveguide assembly 50 includes a protective coating 90 that has an outer surface 92. The protective coating 90 covers at least a substantial portion of top surface 12 of the glass substrate 10. In an example, protective coating 90 covers substantially the entire top surface 12. Also in an example, protective coating 90 covers at least a portion of bottom surface 14. Further in the example, protective coating 90 also covers at least a portion of sides 56. In an example, protective coating 90 is applied to the entire glass substrate 10 except optionally for select regions (e.g., one or more connector regions 15) so that the glass substrate is substantially encapsulated. Thus, the protective coating 90 may or may not include the one or more connector regions 15. In another example, protective coating 90 runs the length in the y-direction of top surface 12 except for the one or more connector regions 15 and further in the example does not extend to sides 56. In an example, protective coating 90 is selectively applied to some or all of the OE-PCB features or components 84 of glass waveguide assembly 50. In an example, the protective coating 90 is applied to the same portion of top surface 12 of glass substrate 10 below which, or at which, the waveguide array 60 is supported. In an example, the protective coating 90 may include a mechanically and thermally reliable material such as resin, polymer, acrylate, silicone, benzocyclobutene, Ormocer or Siloxane that can withstand thermal processes such as PCB lamination. In another example, a thin coating may be overlaid with, include, or be embodied in, a secondary substrate.

In an example, the protective coating 90 is a dielectric material compatible with conventional PCB processing, such as a polymer or a resin. If connectors 80 are formed prior to applying protective coating 90, the connector regions 15 can be left uncoated, e.g., by using a masking process or a selective deposition or coating process or lift-off process. In other examples, connectors 80 include a portion of protective coating 90 as formed on connector regions 15.

The protective coating 90 may function to protect the glass substrate 10 and any other OE-PCB features or components 84 of the glass waveguide assembly 50 during subsequent PCB processing, which can involve relatively high temperatures. A related function of the protective coating 90 is to facilitate the use of PCB processing techniques forming the glass waveguide assembly 50 as well as for forming an OE-PCB as described below. Thus, in an example, the protective coating 90 may be made of a thermally stable material, including such materials that are optically transparent. In an example, the protective coating 90 has a thickness TH2 in the range from 1 μη to 200 μη. Thus, in an example, glass waveguide assembly 50 has a thickness TH3=TH1+2(TH2) when top and bottom surfaces 12 and 14 of glass substrate 10 are coated, or has a thickness TH3=TH1+TH2 when only the top surface of the glass substrate is coated. In certain instances, less than all OE-PCB features or components 84 of the glass waveguide assembly 50 are encapsulated within the protective coating 90. For example, some of the OE-PCB features or components 84 (e.g., conductive vias 110) can extend through protective coating 90. Likewise, connectors 80 as well as some of the optical features or components 82 and the OE-PCB features or components 84 can also extend from or otherwise not be coated with protective coating 90. In an example, OE-PCB features or components 84 in the form of electrical wiring can be formed on an outer surface 92 of the protective coating 90.

FIG. 2A is a magnified side (x-z) cross-sectional view of a peripheral portion of a waveguide assembly 100 showing a waveguide 112 defined along an upper surface 102 of a glass substrate 101, with the waveguide 112 terminating prior to reaching an edge 108 of the glass substrate 101. In an example, the substrate 101 may comprises a glass-based material, such as a glass, a glass-ceramic or a crystal. Examples of glasses can include soda-lime, borosilicate, germanosilicate, aluminosilicate ion-exchanged glasses, non-ion-exchanged glasses, chalcogenide glasses, or fused silica. Examples of crystals can include sapphire, diamond, lithium niobate, lithium tantalite, lithium triborate, barium borate, silicon, silicon nitride, silicon carbide, InP, and GaAs. In certain embodiments, a substrate comprises a planar lightwave circuit or photonic integrated circuit substrate. In certain examples, the substrate 101 can be chemically strengthened, wherein the chemical strengthening can be localized or can extend over the entire volume of the substrate 101. As shown, the waveguide 112 has a waveguide axis AW and an end surface (facet) 116. The example waveguide 112 has an end surface 116 that resides with the glass substrate 101.

FIG. 2B is a magnified side (y-z) cross-sectional view of the waveguide assembly 100 of FIG. 2A showing three waveguides 112 defined along the upper surface 102 of the glass substrate. In an example, the waveguides 112 can be formed in substrate by an ion-exchange process. In another example, the waveguides 112 can be formed in a substrate using a laser-writing process. In other examples, the waveguides 112 can be formed in a substrate or on a substrate using an ion-beam milling process, a photolithography process, an electron-beam lithography process, a thin-film deposition process, a lamination process, etching, deposition, and any other waveguide-forming process known in the art.

Generally, the waveguides 112 define localized regions (which may be recessed or raised relative to a face of a substrate) of increased refractive index relative to remainder of the glass substrate 101. Two example techniques for forming the waveguides 112 include ion exchange and laser writing. For waveguides 112 formed within the glass substrate 101, the surrounding portion of the glass substrate 101 and the region immediately adjacent to the upper surface 102 (when the waveguide is at or near the upper surface) define a cladding for the waveguide 112. For ease of illustration and discussion, waveguides 112 considered herein are shown as formed within the substrate 101 and having a definite boundary with the substrate 101.

FIG. 2C is a perspective view of a waveguide assembly 120 similar to the waveguide assembly 100 shown in FIGS. 2A-2B, but with glass optical waveguides (“waveguides”) 132 extending to front and rear faces 125, 126 of a glass substrate 121. The glass substrate 121 further includes an upper surface 122, a lower surface 124, and side edges 128. The glass substrate 121 has central substrate axis AS that runs through a center of the glass substrate 121 in the x-direction, as well as a length LX in the x-direction and a length LY in the y-direction. As illustrated, the waveguides 132 run in the x-direction and comprise sections of the glass substrate 121 that have been processed to change one or more optical properties thereof. As shown, each waveguide 132 includes an end surface 136 (facet) that resides at the front face 126 of the glass substrate 121, and may include another end surface (not shown) residing at the rear face 125.

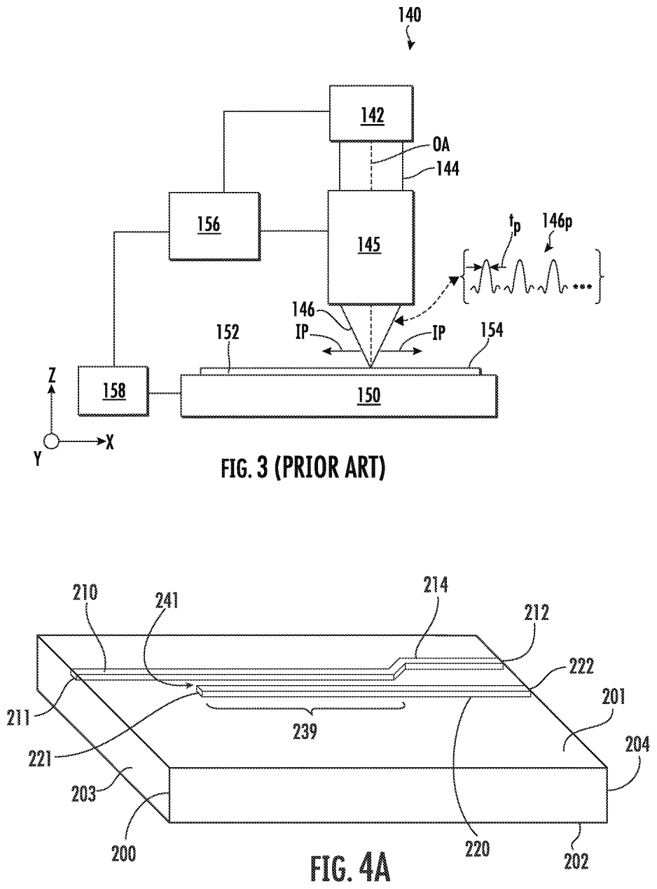

FIG. 3 is a schematic diagram of a laser-based optical processing system (“system”) 140 for processing a glass substrate 152 to form waveguides along an upper surface thereof. The system 140 includes a laser source 142 that emits a laser beam 144 along an optical axis OA. In an example, the laser source 142 is configured to produce pulses 146p having pulses of suitably short duration (e.g., pulses of less than 10 picoseconds). The system 140 also includes a focusing lens 145 arranged to receive the laser beam 144, and a movable support stage 150 that supports the glass substrate 152. The movable support stage 150 is operably connected to a stage controller 158 that controls movement of the support stage 150. The focused laser beam 146 moves relative to the glass substrate 152 over an irradiation path IP and is impinged on the upper surface 154 of the glass substrate 152. The system 140 also includes a main controller 156 connected to the laser source 142, the focusing lens 145, and the stage controller 158 to control operation of the system 140 to define waveguides in the glass substrate 152 (e.g., proximate to the upper surface 154).

Having described methods and apparatuses for forming waveguides in or on substrates (including glass substrate), variable ratio optical couplers according to various embodiments will be introduced.

Various embodiments provide a variable ratio optical coupler that include multiple waveguides arranged in or on a substrate and proximate to one another in at least one coupling region, with a phase change material (PCM) (embodied in a continuous segment in certain embodiments) arranged over a waveguide in the at least one coupling region. Electrode segments are arranged over the PCM at a plurality of overlap regions, and are configured to receive electrical pulses to heat the electrode segment to permit adjustment of a degree of transition between a crystalline state and an amorphous state of the PCM.

Various different optical PCMs may be employed in optical couplers as disclosed herein. Suitable optical PCMs should include a large optical property contrast upon a solid-state phase transition. One example of a suitable optical PCM is Ge₂Sb₂Se₄Te₁ (GSST), which has exceptional broadband optical transparency (low optical loss) and a large optical contrast (e.g., Δn=2.0) with favorable glass forming ability. Other chalcogenide PCMs besides GSST may be used. Another example of an optical PCM that may be used is Ge₂Sb₂Te₅ (GST). GST exhibits greater optical losses than GSST, but GST may exhibit more rapid switching times. In certain embodiments, an optical PCM may be selectively deposited over one or more waveguide regions by formation of a mask (e.g., by photolithographic or e-beam patterning) followed by application of a suitable deposition process through one or more windows in the mask. The foregoing materials generally exist in amorphous and crystalline phases, and can be rapidly and repeatedly switched between these phases through application of electrical and/or optical (e.g., laser) pulses. When a moderate magnitude of voltage pulse (Set pulse) is provided to a PCM and heated to a temperature just above its glass transition temperature (Tg), it forms a crystalline phase or a ‘Set’ state. To switch the material back to the ‘Reset’ state, a higher voltage pulse (Reset pulse) is applied to heat it just above the melting temperature (Tm), and subsequent rapid quenching provides re-amorphization or a ‘Reset’ state. Electrodes may be formed over PCMs (and corresponding traces may be formed over substrate surfaces) by suitable processes such as mask formation and sputtering (or other deposition) of metal(s) or other suitable electrically conductive materials.

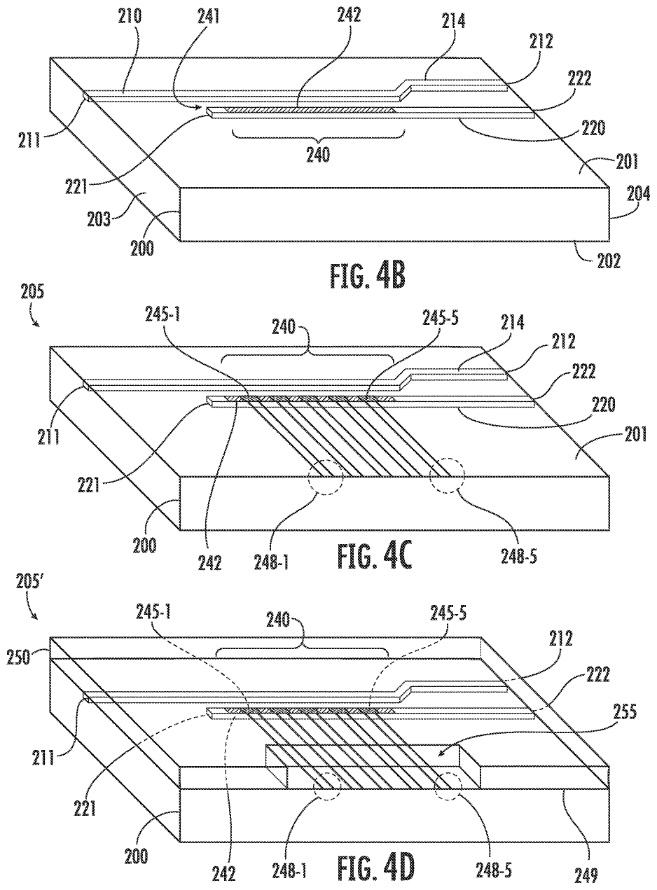

FIGS. 4A-4D are perspective views of a 1×2 (i.e., single input, dual output) variable ratio optical coupler according to one embodiment in four states of fabrication. FIG. 4A shows first and second waveguides 210, 220 defined below an upper face 201 of a primary substrate 200, which may be glass, glass-based, or another substrate material disclosed herein. The substrate 200 includes a lower face 202 that opposes the upper face 201, and includes opposing front and rear ends 203, 204. The first waveguide 210 has first and second ends 211, 212 arranged at the front and rear ends 203, 204, respectively, of the substrate 200, while the second waveguide 220 has a first end 221 arranged at a position between the front and rear ends 204, while a second end 222 of the second waveguide 220 is arranged at the rear end 204 of the substrate 200. A portion of the first waveguide 210 is arranged proximate to a portion of the second waveguide 220 at a proximity region 239, with the first waveguide 210 including a diverging portion 214 positioned apart from the second waveguide 220 and extending to the rear end 204 of the substrate 200. FIG. 4B shows the items of FIG. 4A, following formation of a continuous PCM segment 242 over a portion of the second waveguide 220 at a coupling region 240 wherein a portion of the second waveguide 220 with the PCM segment 242 is proximate to the first waveguide 210.

FIG. 4C shows the items of FIG. 4B following formation of a plurality of sequentially arranged electrode segments 245-1 to 245-5 over the continuous PCM segment 242 in the coupling region 240, and formation of multiple pairs of conductive traces 248-1 to 248-5, to form a variable ratio optical coupler 205. The first end 211 of the first waveguide 210 may serve as an optical input providing an optical input signal to the variable ratio optical coupler 205, and the second ends 212, 222 of the first and second waveguides 210, 222 respectively, may serve as optical outputs, each receiving a portion of the optical input signal. A portion of the optical power of the optical input signal is propagated from the first waveguide 210 to the second waveguide 220 by evanescent coupling in the coupling region 240. Each pair of conductive traces 248-1 to 248-5 is conductively coupled to a corresponding electrode segment 245-1 to 245-5. Regions where the electrode segments 245-1 to 245-5 overlap portions of the continuous PCM segment 242 may be termed overlap regions. It may be beneficial to provide a continuous PCM segment 242 in the coupling region 240, as opposed to multiple segregated PCM segments, to reduce potential scattering of light in the second waveguide 220 that could otherwise occur along PCM boundaries. Moreover, a leading end and/or trailing end of the continuous PCM segment 242 may have a reduced (e.g., tapered) width, to similarly reduce scattering of light between waveguides that could otherwise occur proximate to ends of a constant width PCM segment 242. Although FIG. 4C shows the pairs of conductive traces 248-1 to 248-5 as extending to a lateral edge of the substrate 200, it is to be appreciated that the pairs of conductive traces 248-1 to 248-5 may be routed to any desired portion of the substrate 200.

FIG. 4D shows the items of FIG. 4C following addition of an optional secondary substrate 250 (which may embody or include a protective layer, and arranged at interface 249) over the waveguides 210, 220, the continuous PCM segment 242, the electrode segments 245-1 to 245-5, and at least portions of the conductive traces 248-1 to 248-5, to yield a variable ratio optical coupler 205′. FIG. 4D shows that the secondary substrate 250 may optionally include a recess 255 providing access to portions of the conductive traces 248-1 to 248-5. Electrical signals (e.g., pulses) may be provided to individual pairs of conductive traces 248-1 248-5 and propagated to the corresponding individual electrodes 245-1 to 245-5 to cause localized heating of the electrodes 245-1 to 245-5 and therefore localized heating of the PCM segment 242 at the overlap regions (i.e., where the PCM segment 242 is overlapped by the electrodes 245-1 to 245-5). Specifically, any combination of one or more of the electrodes 245-1 to 245-5 may be heated to affect a transition between amorphous and crystalline state of phase change material of the PCM segment 242 at the overlap regions, to locally affect optical properties of the second waveguide 220 and adjust optical power transfer between the first waveguide 210 and the second waveguide 220.

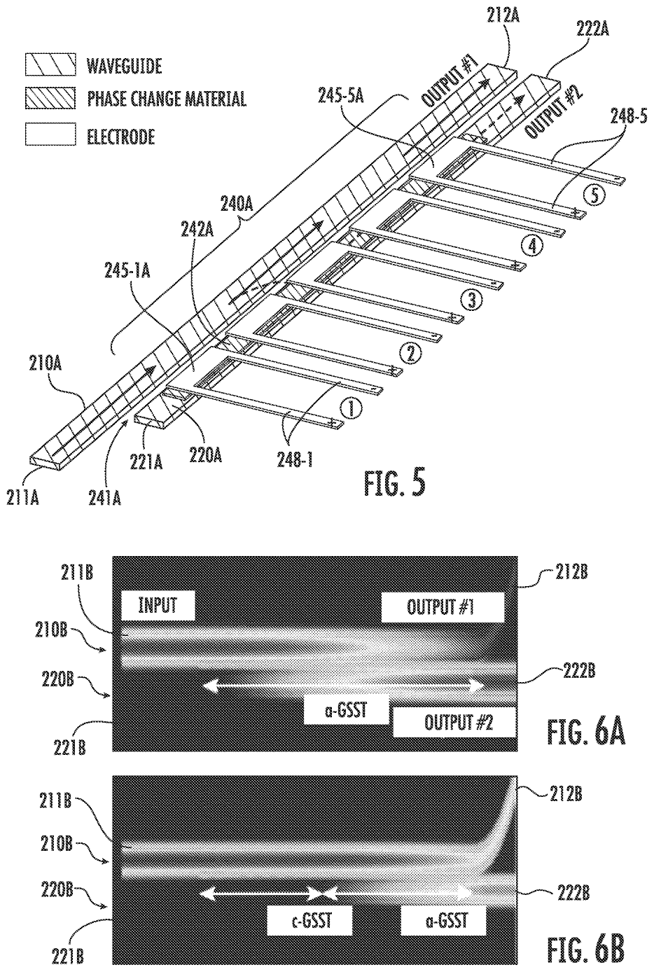

FIG. 5 is a perspective view schematic of adjacent first and second waveguide portions 210A, 220A of a variable ratio optical coupler according to one embodiment, with a continuous PCM segment 242A arranged over the second waveguide 220A at a coupling region 240A, and with first through fifth electrodes 245-1A to 245-5A arranged over portions of the continuous PCM segment 242A to form overlap regions. Each electrode 245-1A to 245-5A is conductively coupled with a corresponding pair of conductive traces 248-1A to 248-5A. A first end 211A of the first waveguide 210A serves as an optical input to provide an optical input signal to the variable ratio optical coupler, and second ends 212A, 222A of the first and second waveguides 210A, 222A respectively, serve as optical outputs, each receiving a portion of the optical input signal, wherein a portion of optical power of the optical input signal is propagated from the first waveguide 210A to the second waveguide 220A by evanescent coupling in the coupling region 240A. Any combination of one or more of the electrodes 245-1A to 245-5A may be heated (by supplying signals through the conductive traces 248-1A to 248-5A) to affect a transition between amorphous and crystalline state of phase change material of the PCM segment 242A at the overlap regions (corresponding to locations of the electrodes 245-1A, 245-5A), to locally affect optical properties of the second waveguide 220A in the coupling region 240A and thereby adjust optical power transfer between the first waveguide 210A and the second waveguide 220A.

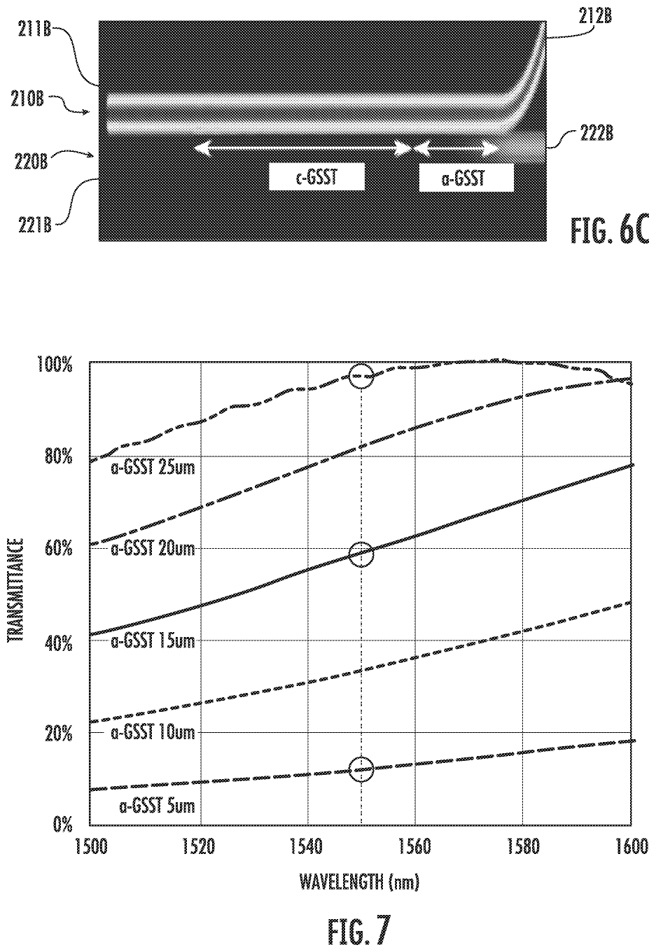

FIGS. 6A-6C are modeled field distribution diagrams for a two-waveguide 1×2 variable ratio optical coupler corresponding generally to the configuration shown in FIG. 5 with different proportions of Ge₂Sb₂Se₄Te₁ (GSST) phase change material in an amorphous versus crystalline state following application of electrical pulses to different combinations of first through fifth electrodes (e.g., 245-1A to 245-5A in FIG. 5, but not shown in FIGS. 6A-6C). FIGS. 6A-6C show a first waveguide 210B having an upstream (input) portion 211B and a downstream (output) portion 212B, and a second waveguide having 220B having an upstream portion 221B and a downstream (output) portion 222B, wherein the foregoing portions 211B, 212B, 221B, 222B may represent a central region of a coupler device without illustrating ends thereof. If five sequential overlap regions are provided, each formed by a corresponding electrode 5 μm long electrodes, then a transition between amorphous and crystalline state of GSST phase change material may be adjusted in 5 μm long increments.

FIG. 6A represents a 25 μm length of GSST phase change material in an amorphous state (i.e., “a-GSST”), which may be attained by applying electrical pulses to each of five 5 μm long electrodes (e.g., 245-1A to 245-5A in FIG. 5) to change GSST material overlapped by the electrodes from a crystalline state to an amorphous state. FIG. 6B represents a 15 μm length of a-GSST and a 10 μm length of GSST in a crystalline state (i.e., “c-GSST”), obtainable by applying pulses to three of five 5 μm long electrodes (e.g., 245-3A to 245-5A in FIG. 5) to change GSST material to amorphous state. FIG. 6C represents a 5 μm length of a-GSST and a 20 μm length of c-GSST, obtainable by applying pulses to one of five 5 μm long electrodes (e.g., 245-5A in FIG. 5) to change GSST material to amorphous state. The results shown in FIGS. 6A-6C (and also in FIG. 7) were obtained using the FDTD Lumerical solver (Ansys, Inc., Canonsburg, Pennsylvania, USA).

FIG. 7 is a plot of calculated transmission spectrum (transmittance versus wavelength over a wavelength range of 1500 to 1600 nm) of one tap output (i.e., output portion 222B in FIGS. 6A-6C) of a GSST-covered waveguide according to FIGS. 6A-6C with five overlap regions (shown in FIG. 5) when the amorphous GSST sections decrease in aggregate length from 25 μm to 5 μm, and concomitantly when the crystalline GSST increase in aggregate length from 0 μm to 20 μm, in increments of 5 μm. When all sections of the GSST segment are in the amorphous state, the coupling ratio is very high (with transmittance varying from about 80 percent to 99.5 percent (at 1570 nm) over a wavelength range of 1500 to 1600 nm), as shown in the topmost curve in FIG. 7. As increasing sections of the GSST segment are tuned from the amorphous state to the crystalline state, the coupling ratio of the tap output is decreased at specific wavelengths, as shown by the lowermost four curves of FIG. 7.

Besides changing the proportion of amorphous phase and crystalline phase of a PCM such as GSST, optical coupling between waveguides can be affected by the gap between adjacent waveguides in a coupling region.

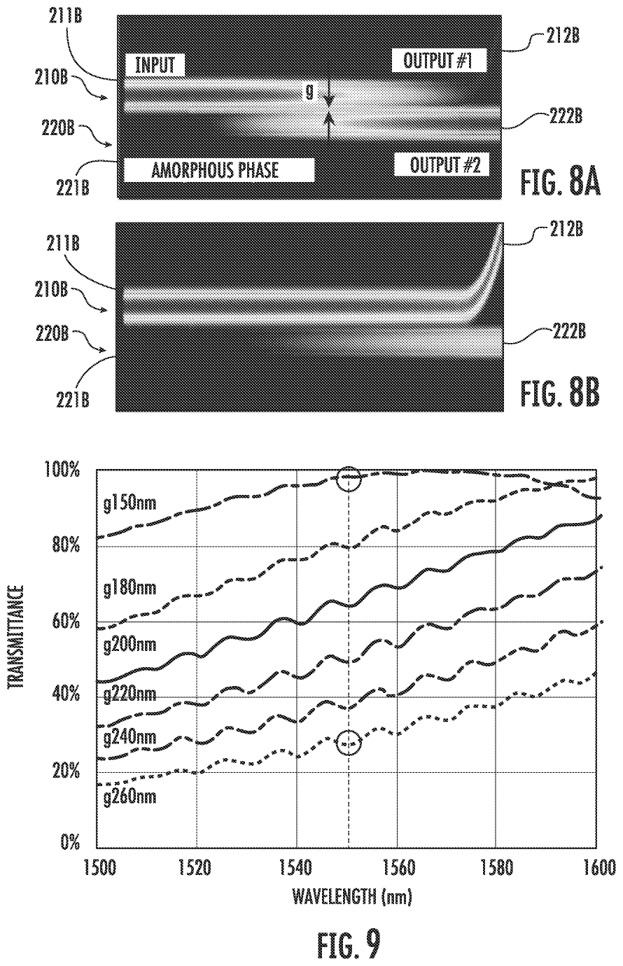

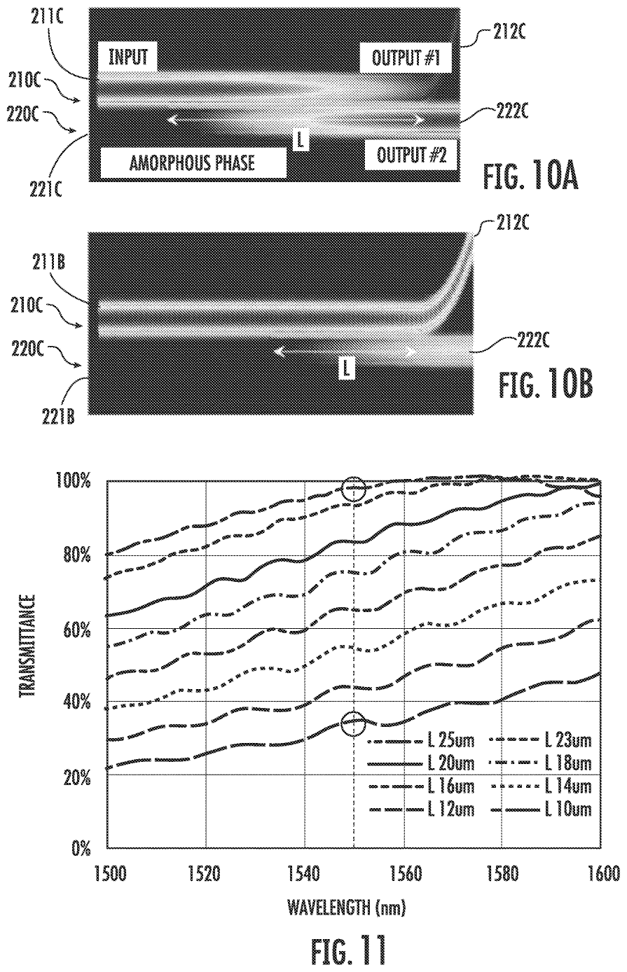

FIGS. 8A and 8B are modeled field distribution diagrams for a two-waveguide 1×2 variable ratio optical coupler corresponding generally to the configuration shown in FIG. 5 with different gap distances between the two waveguides, namely, a gap distance of 150 nm in FIG. 8A and a gap distance of 250 nm in FIG. 8B. FIGS. 8A-8B show a first waveguide 210B having an upstream (input) portion 211B and a downstream (output) portion 212B, and a second waveguide having 220B having an upstream portion 221B and a downstream (output) portion 222B, wherein the foregoing portions 211B, 212B, 221B, 222B may represent a central region of a coupler device without illustrating ends thereof. The first waveguide 210B and the second waveguide 220B are separated by a gap g. FIG. 9 is a plot of calculated transmission spectrum (transmittance versus wavelength) of one tap output (i.e., output portion 222B in FIGS. 8A-8B) of a GSST-covered waveguide according to FIGS. 8A-8B when the gap g between waveguides 210B, 220B increases from 150 nm to 260 nm with steps of 20 or 30 nm. As shown, smaller gap distances correspondence to increased transmittance (and therefore increased optical power transfer between waveguides 210B, 220B).

Optical coupling between waveguides may also be affected by coupling length where waveguides, including a waveguide overlaid with phase change material in an amorphous state, are adjacent to one another. FIGS. 10A and 10B are modeled field distribution diagrams for a two-waveguide 1×2 variable ratio optical coupler corresponding generally to the configuration shown in FIG. 5 with different coupling lengths between the two waveguides, namely, a coupling length of 25 μm in FIG. 10A and a coupling length of 10 μm in FIG. 10B, wherein a gap between the waveguides is unchanged at 150 nm. FIGS. 10A-10B show a first waveguide 210B having an upstream (input) portion 211B and a downstream (output) portion 212B, and a second waveguide having 220B having an upstream portion 221B and a downstream (output) portion 222B, wherein the foregoing portions 211B, 212B, 221B, 222B may represent a central region of a coupler device without illustrating ends thereof. A region where the first waveguide 210B and the second waveguide 220B are adjacent to one another has a length L. FIG. 11 is a plot of calculated transmission spectrum (transmittance versus wavelength) of a tap output of the GSST-covered waveguide according to FIGS. 10A-10B when the coupling length degreases from 25 μm (at top) to 10 μm (at bottom) in steps of 2 μm or 3 μm. Transmission can be tuned from 98 percent to 35 percent at the wavelength of 1550 nm by adjusting coupling length, wherein it is noted that transmission may be further reduced at smaller coupling lengths.

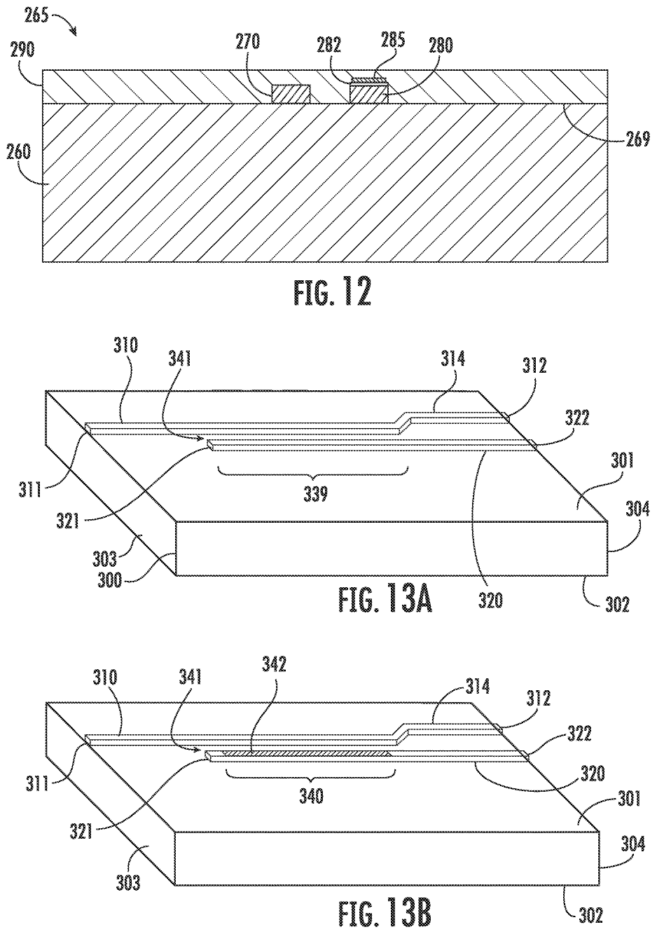

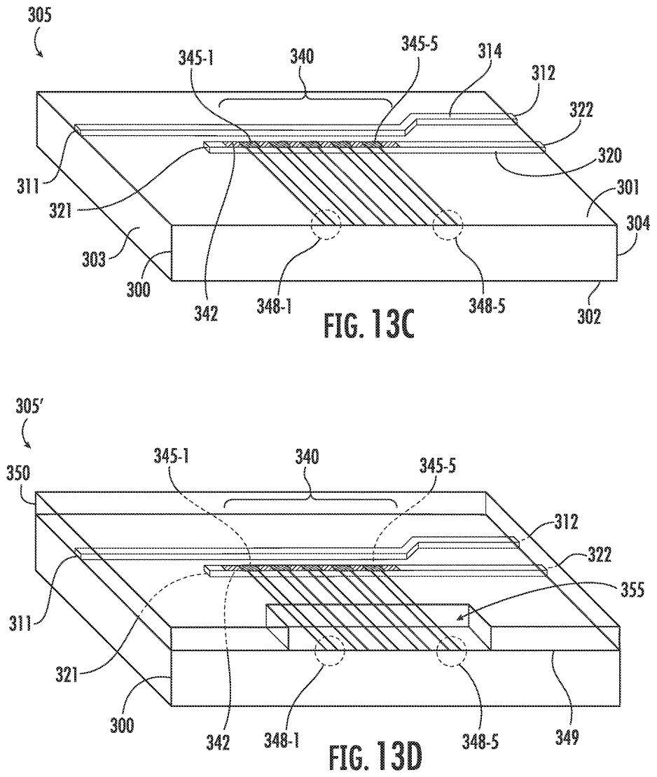

Although prior illustrated various ratio optical coupler embodiments (e.g., in FIGS. 4A-4D) included waveguides formed below a face of a substrate, in certain embodiments (e.g., shown in FIGS. 12 and 13A-13D), waveguides may be elevated relative to an underlying substrate. As one example, FIG. 12 is a cross-sectional view of a portion of a variable ratio optical coupler according to one embodiment including first and second waveguides 270, 280 that are arranged on (i.e., raised relative to) an upper face 269 of a primary substrate 260, with a PCM segment 282 arranged over one waveguide 280, and an electrode 285 arranged over the PCM segment 282.

FIGS. 13A-13D are perspective views of a 1×2 variable ratio optical coupler according to one embodiment in four states of fabrication. FIG. 13A shows first and second waveguides 310, 320 extending above an upper face 301 of a primary substrate 300, which may be glass, glass-based, or another substrate material disclosed herein. The primary substrate 300 includes a lower face 302 that opposes the upper face 301, and includes opposing front and rear ends 303, 304. The first waveguide 310 has first and second ends 311, 312 arranged at the front and rear ends 303, 304, respectively, of the substrate 300, while the second waveguide 320 has a first end 321 arranged at a position between the front and rear ends 304, while a second end 322 of the second waveguide 320 is arranged at the rear end 304 of the substrate 300. A portion of the first waveguide 310 is arranged proximate to a portion of the second waveguide 320 at a proximity region 339, with the first waveguide 310 including a diverging portion 314 positioned apart from the second waveguide 320 and extending to the rear end 304 of the substrate 300. FIG. 13B shows the items of FIG. 13A, following formation of a continuous PCM segment 342 over a portion of the second waveguide 320 at a coupling region 340 wherein a portion of the second waveguide 320 is proximate to the first waveguide 310.

FIG. 13C shows the items of FIG. 13B following formation of a plurality of sequentially arranged electrode segments 345-1 to 345-5 over the continuous PCM segment 342 in the coupling region 340, and formation of multiple pairs of conductive traces 348-1 to 348-5, to form a variable ratio optical coupler 305. The first end 311 of the first waveguide 310 may serve as an optical input providing an optical input signal to the variable ratio optical coupler 305, and the second ends 312, 322 of the first and second waveguides 310, 322 respectively, may serve as optical outputs, each receiving a portion of the optical input signal. A portion of the optical power of the optical input signal is propagated from the first waveguide 310 to the second waveguide 320 by evanescent coupling in the coupling region 340. Each pair of conductive traces 348-1 to 348-5 is conductively coupled to a corresponding electrode segment 345-1 to 345-5. Regions where the electrode segments 345-1 to 345-5 overlap portions of the continuous PCM segment 342 may be termed overlap regions.

FIG. 13D shows the items of FIG. 13C following addition of an optional secondary substrate 350 (which may embody or include a protective layer, and arranged at interface 349) over the waveguides 310, 320, the continuous PCM segment 342, the electrode segments 345-1 to 345-5, and at least portions of the conductive traces 348-1 to 348-5, to yield a variable ratio optical coupler 305′. FIG. 13D shows that the secondary substrate 350 may optionally include a recess 355 providing access to portions of the conductive traces 348-1 to 348-5. Electrical signals (e.g., pulses) may be provided to individual pairs of conductive traces 348-1 348-5 and propagated to the corresponding individual electrodes 345-1 to 345-5 to cause localized heating of the electrodes 345-1 to 345-5 and therefore localized heating of the PCM segment 342 at the overlap regions (i.e., where the PCM segment 342 is overlapped by the electrodes 345-1 to 345-5) to locally affect optical properties of the second waveguide 320 and adjust optical power transfer between the first waveguide 310 and the second waveguide 320.

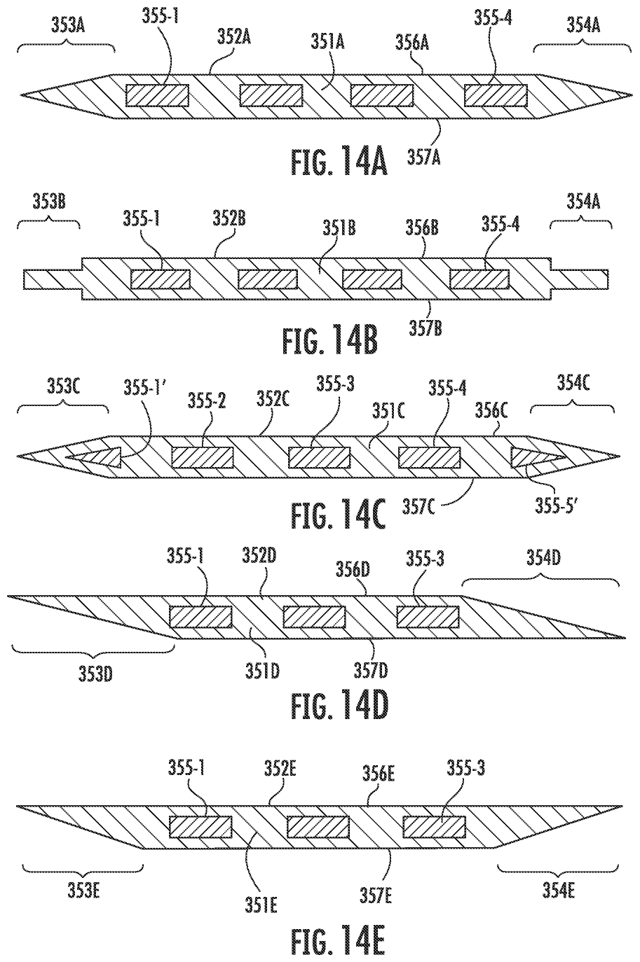

As noted previously herein, a leading end and/or trailing end of a PCM segment of a variable ratio optical coupler according to certain embodiments may have a reduced (e.g., tapered) width, in order to reduce scattering of light between adjacent waveguides that would otherwise occur proximate to ends of a constant width PCM segment. FIGS. 14A-14E are top plan views of PCM segments 352A-352E having end portions 353A-353E, 354A-354E with tapered or reduced widths according to certain embodiments. FIG. 14A shows a PCM segment 352A having a constant width central portion 351A bounded by side edges 356A, 357A and having symmetrically tapered (e.g., having a triangular shape) end portions 353A, 354A, with four sequentially arranged, generally rectangular electrodes 355-1 to 355-4 overlying the central portion 351A. FIG. 14B shows a PCM segment 352B having a constant width central portion 351B bounded by side edges 356B, 357B and having reduced and constant width (e.g., having rectangular shape) end portions 353B, 354B, with four sequentially arranged, generally rectangular electrodes 355-1 to 355-4 overlying the central portion 351B. FIG. 14C shows a PCM segment 352C having a constant width central portion 351C bounded by side edges 356C, 357C and having symmetrically tapered (e.g., having a triangular shape) end portions 353C, 354C, with reduced width electrodes 355-1′, 355-5′ electrodes arranged in or near the end portions 353C, 354C, and with constant width electrodes 355-2 to 355-4 overlying the central portion 351C. FIG. 14D shows a PCM segment 352D having a constant width central portion 351D bounded by side edges 356D, 357D and having asymmetrically tapered (e.g., having a right triangular shape) end portions 353D, 354D, with three sequentially arranged, generally rectangular electrodes 355-1 to 355-3 overlying the central portion 351D. As shown, one end portion 353D has a width that increases in a direction toward side edge 357D with proximity to the central portion 351D, and the other end portion 354D has a width that increases in a direction toward side edge 356D with proximity to the central portion 351D. FIG. 14E shows a PCM segment 352E having a constant width central portion 351E bounded by side edges 356E, 357E and having asymmetrically tapered (e.g., having a right triangular shape) end portions 353E, 354E, with three sequentially arranged, generally rectangular electrodes 355-1 to 355-3 overlying the central portion 351E. As shown, each end portion 353E, 354E has a width that increases in a direction toward side edge 357E with proximity to the central portion 351E.

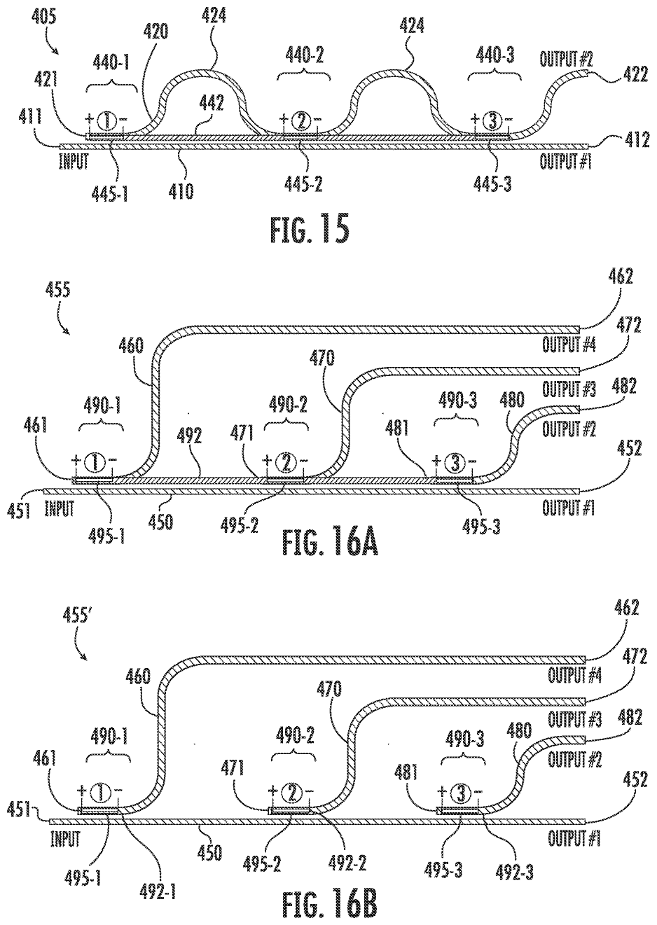

In certain embodiments, a variable ratio optical coupler may include a continuous PCM segment arranged over multiple non-adjacent coupling regions, wherein waveguides may diverge from and reconverge toward one another between pairs of coupling regions. FIG. 15 is a schematic top view of a 1×2 variable ratio optical coupler 405 including first and second waveguides 410, 420 (having corresponding first ends 411, 421 and second ends 412, 422) arranged in or on a substrate (not shown), with the waveguides 410, 420 being proximate to one another at three coupling regions 440-1 to 440-3, but with the waveguides 410, 420 diverging from and reconverging toward one another at diverging regions 424 between the coupling regions 440-1 to 440-3. A continuous PCM segment 442 extends across and between the coupling regions 440-1 to 440-3, and is arranged over the second waveguide 420 at the coupling regions 440-1 to 440-3. Moreover, electrodes 445-1 to 445-3 are arranged over the PCM segment 442 at the coupling regions 440-1 to 440-3 to form overlap regions where the PCM segment 442 is subject to localized heating by the electrodes 445-1 to 445-3 to permit local adjustment of a degree of transition between a crystalline state and an amorphous state of the phase change material of the PCM segment 442. In use, an optical input signal is supplied at the first end 411 of the first waveguide 410, wherein portions of optical power of the input signal are transferred to the second waveguide 420 at the coupling regions 440-1 to 440-3, and resulting divided output power portions of the input signal are transmitted to the second ends 412, 422 of the waveguides 410, 420. By providing multiple non-adjacent coupling regions, parameters such as inter-waveguide gap and coupling length may be tailored to provide desired results, wherein power coupling or splitting ratios may be further adjusted at each coupling region using the electrodes 445-1 to 445-3. For example, the gap and coupling length may be selected at the first to third coupling regions 440-1 to 440-3 to permit 10%, 20%, and 30% coupling/splitting ratios, wherein providing electrical pulses to individual electrodes 440-1 to 440-3 to change the PCM from crystalline state to amorphous state may enable or disable optical power transfer in individual coupling regions 440-1 to 440-3. If the PCM is in the crystalline state at an individual coupling region 440-1 to 440-3, then the waveguides will not be phase-matched and no optical power coupling will be provided. Although only one electrode 445-1 to 445-3 per coupling region 440-1 to 440-3 is shown, in certain embodiments multiple electrodes may be provided for each coupling region 440-1 to 440-3.

In certain embodiments, a variable ratio optical coupler may include a continuous PCM segment arranged over multiple non-adjacent coupling regions, wherein input signals from one waveguide may be propagated to multiple other waveguides at different coupling regions.

FIG. 16A is a schematic top view of a 1×4 variable ratio optical coupler 455 providing four outputs according to one embodiment. The variable ratio optical coupler 455 includes first to fourth waveguides 450, 460, 470, 480 (having corresponding first ends 451, 461, 471, 481 and second ends 452, 462, 472, 482) arranged in or on a substrate (not shown), with paired waveguides 450, 460, 470, 480 being proximate to one another at three coupling regions 490-1 to 490-3. A continuous PCM segment 492 extends across and between the coupling regions 490-1 to 490-3, and are arranged over corresponding portions of the second to fourth waveguides 460, 470, 480 at the coupling regions 490-1 to 490-3. Moreover, electrodes 495-1 to 495-3 are arranged over the PCM segment 492 at the coupling regions 490-1 to 490-3 to form overlap regions where the PCM segment 492 is subject to localized heating by the electrodes 495-1 to 495-3 to permit local adjustment of a degree of transition between a crystalline state and an amorphous state of the phase change material of the PCM segment 492. In use, an optical input signal is supplied at the first end 451 of the first waveguide 450, wherein portions of optical power of the input signal are transferred to the second, third, and fourth waveguides 460, 470, 480 at the coupling regions 490-1 to 490-3, and resulting divided output power portions of the input signal are transmitted to the second ends 452, 462, 472, 482, 422 of the waveguides 410, 420.

Although FIG. 16A illustrates a continuous PCM segment 492 extends across and between the coupling regions 490-1 to 490-3, in certain embodiments multiple discontinuous PCM segments may be provided, with each separate PCM segment being provided over a different coupling region. One embodiment showing such an arrangement is shown in FIG. 16B, which illustrates a 1×4 variable ratio optical coupler 455′ that is substantially identical to the variable ratio optical coupler 455 shown in FIG. 16A, except that multiple discontinuous PCM segments 492-1 to 492-3 are provided at corresponding overlap regions 490-1 to 490-3 instead of a continuous PCM segment spanning across and between overlap regions 490-1 to 490-3 as shown in FIG. 16A. The remaining elements and operation of the variable ratio optical coupler 455′ of FIG. 16B are the same as previously described in connection with FIG. 16A, and will not be described again.

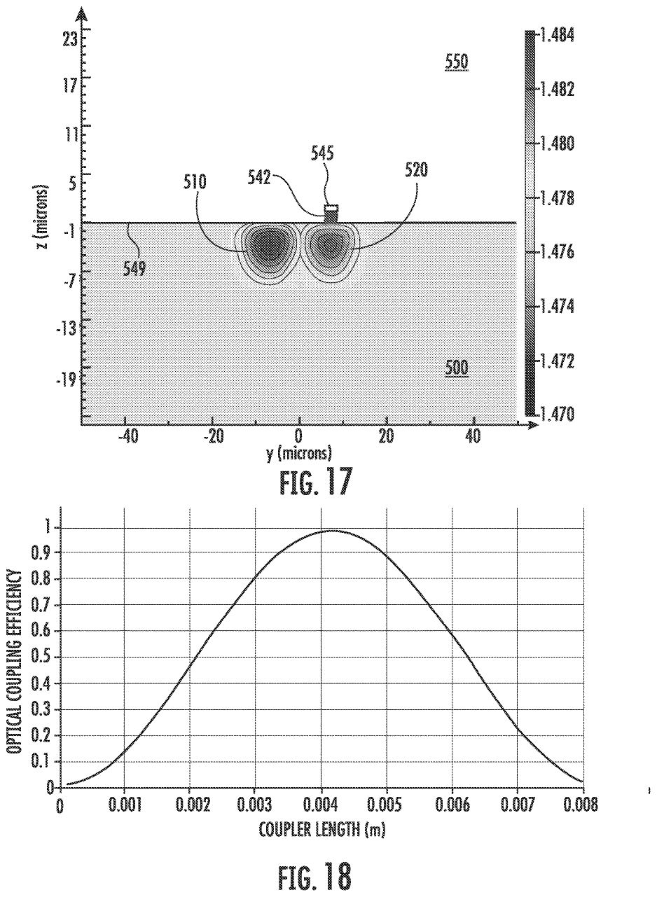

FIG. 17 is a transverse cross-sectional view of a 1×2 variable ratio optical coupler including two ion exchanged (IOX) waveguides 510, 520 arranged in a primary substrate 500 with a continuous PCM segment (i.e., layer) 542 arranged over one waveguide 520, and with an electrode 545 arranged over the PCM segment 542. The IOX waveguides 510, 520 have refractive index profiles designed to provide phase-matching between the modes of the waveguides 510, 520, modified by the PCM segment 542, wherein optical power transfer between the waveguides 510, 520 occurs by evanescent coupling when the PCM segment 542 is in the amorphous state. As shown the waveguides 510, 520 are formed within the primary substrate 500 below an upper face 549, while the PCM segment 542 is arranged on the upper face 549 over one waveguide 520. A secondary substrate and/or protective material layer 550 may be arranged over the upper face 549 as well as over the PCM segment 542 and the electrode 545. Ion exchanged glass waveguide parameters can be adjusted via IOX mask opening and process parameter control to achieve difference in guided mode effective index values of the waveguides required for realization of the coupler design.

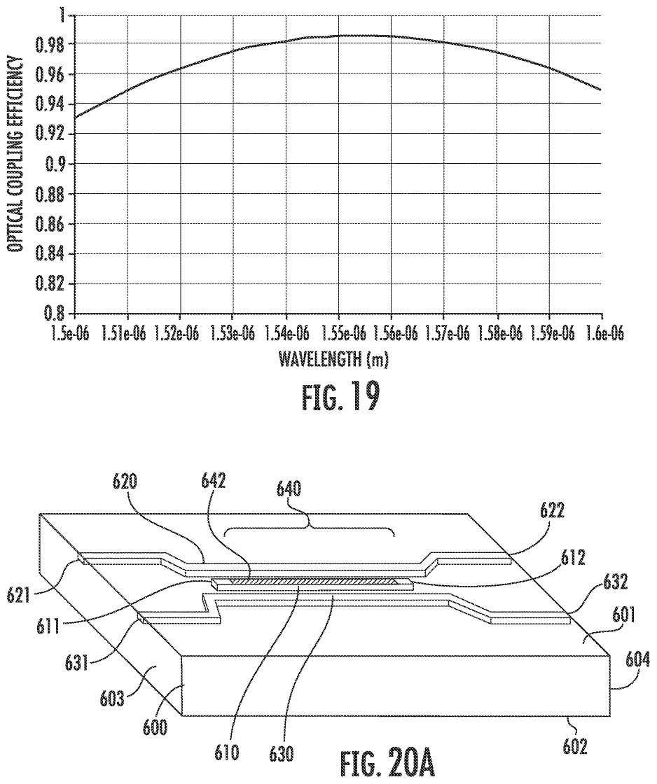

FIG. 18 is a plot of optical coupling efficiency at 1550 nm wavelength versus coupler length, modeled for a variable ratio optical coupler according to FIG. 17. Optical coupling efficiency simulated for a design with 565 nm wide and 50nm thin GSST film shows that coupler length of 4 mm is required for power transfer with >98% efficiency. FIG. 19 is a plot of optical coupling efficiency versus wavelength computed for a variable ratio optical coupler according to FIG. 17 having about a 4 mm coupling length, showing operation with greater than 92% efficiency is computer computed for a wavelength band from about 1500 nm to 1600 nm.

In certain embodiments, bidirectional (e.g., 2×2) power coupling may be provided through a waveguide having arranged thereon a PCM segment and one or more corresponding electrodes. In certain embodiments, an intermediate waveguide (e.g., a center waveguide) having an associated PCM may be arranged at a different height or depth relative to multiple adjacent waveguides in a coupling region, to provide higher sensitivity to a PCM layer arranged thereon. Optical power transfer between outer waveguides may be provided via mode phase matching with a center waveguide having PCM thereon when the PCM is in the amorphous state.

FIGS. 20A and 20B are perspective views of a 2×2 variable ratio optical coupler according to one embodiment in two states of fabrication. FIG. 20A shows first to third waveguides 610, 620, 630 defined in a primary substrate 600 proximate to an upper face 601 thereof. The primary substrate 600 includes a lower face 602 that opposes the upper face 601, and includes opposing front and rear ends 603, 604. The first waveguide 610 has first and second ends 611, 612 that are non-coincident with the front and rear ends, with the first waveguide 610 embodying a center waveguide arranged between, and having a reduced length relative to, the second and third waveguides 620, 630. The second and third waveguides 620, 630 have first ends 621, 631 at the front end 603 of the substrate 600, and have second ends 622, 632 at the rear end 604 of the substrate 600. A portion of the first waveguide 610 has a continuous PCM segment 642 arranged thereon. Portions of the second waveguide 620 and the third waveguide 630 are arranged proximate to the portion of the first waveguide 610 covered with the PCM segment 642 at a coupling region 640.

FIG. 20B shows the items of FIG. 20A following formation of a plurality of sequentially arranged electrode segments 345-1 to 645-5 over the continuous PCM segment 642 in the coupling region 640, and formation of multiple pairs of conductive traces 648-1 to 648-5, to form a variable ratio optical coupler 605. Optical power transfer between the second and third (outer) waveguides 620, 630 may be provided via mode phase matching with the first (center) waveguide 610 when at least a portion of the PCM segment 642 on the first waveguide 610 is in the amorphous state. The first ends 621, 622 of the second and third waveguides 620, 630 may serve as an optical inputs providing optical input signals to the variable ratio optical coupler 605, and the second ends 622, 632 of the second and third waveguides 620, 632 respectively, may serve as optical outputs to each receive portion of the optical input signals, or vice-versa. A portion of the optical power of the optical input signal is propagated from the second waveguide 620 through the first waveguide 610 to the third waveguide 630 (and vice-versa) by evanescent coupling in the coupling region 640. Each pair of the conductive traces 648-1 to 648-5 is conductively coupled to a corresponding electrode segment 645-1 to 645-5. Regions where the electrode segments 645-1 to 645-5 overlap portions of the continuous PCM segment 642 may be termed overlap regions, and localized portions of the PCM segment 642 in the overlap regions may be switched between a crystalline and amorphous state to adjust optical power transfer between the second and third waveguides 620, 630.

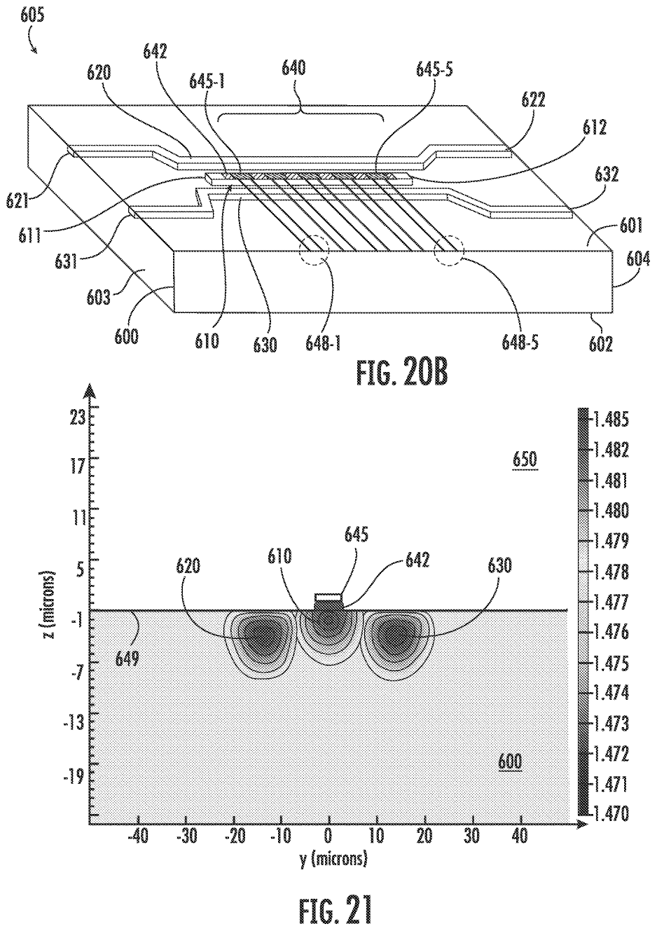

FIG. 21 is a transverse cross-sectional view of a 2×2 variable ratio optical coupler (generally according to the design of FIG. 20) including three ion exchanged (IOX) waveguides 610, 620, 630 arranged in a primary substrate 600 with a PCM layer 642 and associated electrode 645 arranged over the center waveguide 610. The center waveguide 610 is configured as a surface waveguide (closer to an upper face 649 of the primary substrate 650) with the surrounding waveguides 620, 630 being configured as buried waveguides at a greater depth relative to the upper face 649 of the primary substrate 600. A secondary substrate and/or protective material layer 650 may be arranged over the upper face 649 as well as over the PCM segment 642 and the electrode 648-5.

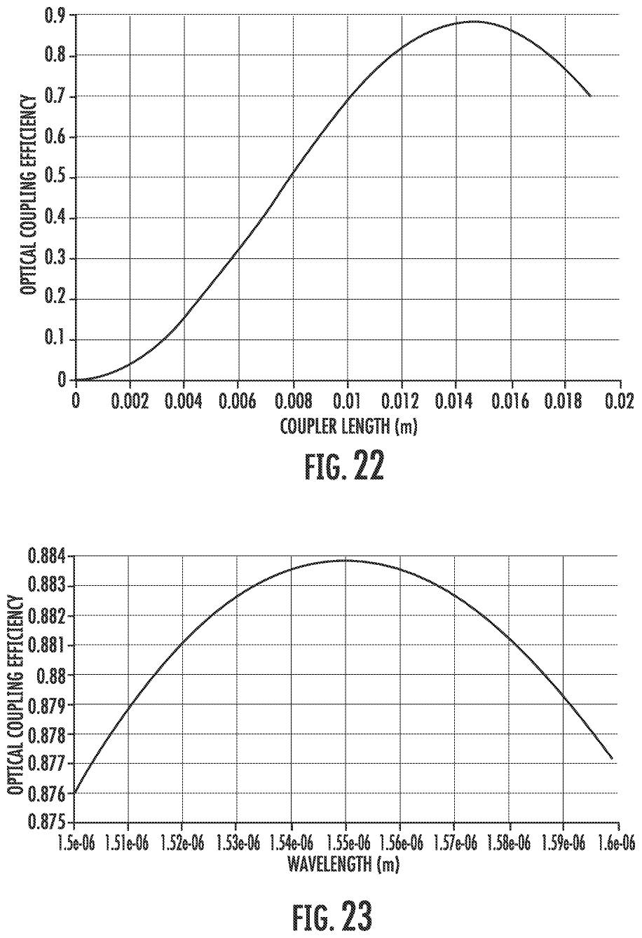

FIG. 22 is a plot of optical coupling efficiency at 1550 nm wavelength versus coupler length, computed for a variable ratio optical coupler according to FIG. 21, with PCM in the form of GSST having width and thickness dimensions of 1500 nm by 46 nm. Such figure shows that a coupler length of about 14 mm is required for optical power transfer with greater than 90 percent efficiency. FIG. 23 is a plot of optical coupling efficiency versus wavelength computed for a variable ratio optical coupler according to FIG. 21 having a 14 mm coupling length, showing that greater than about 87.5 percent efficiency is attained throughout the 1500 nm to 1600 nm wavelength band.

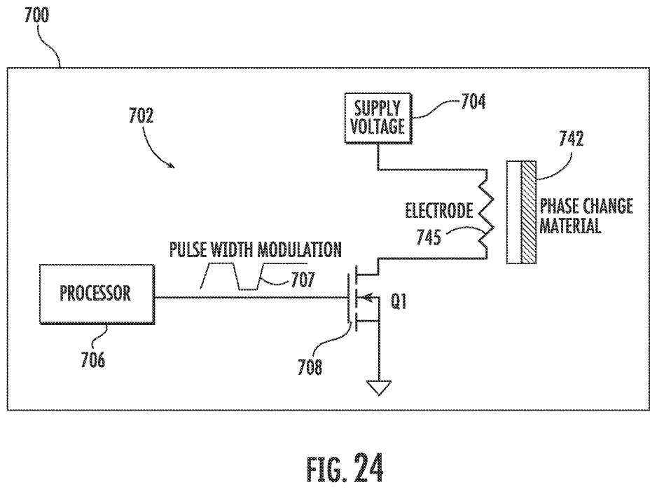

FIG. 24 is a circuit diagram for a tuning circuit 702, embodied in a tuning device 700, configured to deliver electrical pulses to at least one electrode segment 745 of a variable ratio optical coupler as disclosed herein to heat the at least one electrode segment to permit adjustment of a degree of transition between a crystalline state and an amorphous state of phase change material 742. The tuning circuit 742 includes a processor 706 configured to generate a pulsed (e.g., pulse width modulated) signal 707 that is supplied to a transistor 708 (optionally embodied in a MOSFET), that controls application of voltage from a voltage source 704 to the electrode 745. In certain embodiments, the tuning device 700 may include multiple tuning circuits 702 to permit simultaneous application of electrical pulses to multiple electrodes of a variable ratio optical coupler as disclosed herein.

In certain embodiments, the tuning device 700 may be used in a field location (e.g., outside of a factory) to permit a technician or customer to tune one or more variable ratio optical couplers as disclosed herein. In certain embodiments, the tuning device 700 may be combined with one or more variable ratio optical couplers as disclosed herein in a kit for sale to, and/or use by, a technician or customer.

The subject-matter of the disclosure may also relate, among others, to the following aspects:

According to aspect (1), a variable ratio optical coupler is provided. The variable ratio optical coupler comprises: first and second waveguides arranged in or on a primary substrate, wherein a portion of the first waveguide and a portion of the second waveguide are arranged proximate to one another in at least one coupling region and configured for optical power transfer by evanescent coupling; a continuous phase change material segment arranged over the portion of the first waveguide in the at least one coupling region; and a plurality of electrode segments sequentially arranged over the continuous phase change material segment at a plurality of overlap regions; wherein each electrode segment of the plurality of electrode segments is arranged over a corresponding overlap region of the plurality of overlap regions, and each electrode segment is arranged to receive electrical pulses configured to heat the electrode segment to permit adjustment of a degree of transition between a crystalline state and an amorphous state of phase change material of the continuous phase change material segment at the corresponding overlap region.

According to aspect (2), the variable ratio optical coupler of aspect (1) is provided, further comprising a plurality of electrically conductive traces deposited on the primary substrate and conductively coupled with the plurality of electrode segments.

According to aspect (3), the variable ratio optical coupler of aspect (1) or aspect (2) is provided, wherein the primary substrate comprises a glass or glass-based material, and each of the first waveguide and the second waveguide comprises an ion exchanged (IOX) waveguide arranged in the primary substrate.

According to aspect (4), the variable ratio optical coupler of aspect (1) or aspect (2) is provided, wherein the primary substrate comprises any of: a silicon nitride substrate, a silicon-on-insulator substrate, and a planar lightwave circuit substrate.

According to aspect (5), the variable ratio optical coupler of any one of aspects (1) to (4) is provided, wherein the continuous phase change material segment comprises Ge₂Sb₂Se₄Te₁ (GSST).

According to aspect (6), the variable ratio optical coupler of any one of aspects (1) to (5) is provided, wherein the continuous phase change material segment comprises a first end with a tapered width and comprises a second end with a tapered width.

According to aspect (7), the variable ratio optical coupler of any one of aspects (1) to (6) is provided, further comprising a secondary substrate arranged over the plurality of electrode segments, the continuous phase change material segment, the first and second waveguides, and the primary substrate, wherein the secondary substrate comprises a lower index of refraction than an index of refraction of the primary substrate.

According to aspect (8), the variable ratio optical coupler of any one of aspects (1) to (7) is provided, wherein the at least one coupling region comprises a plurality of coupling regions, wherein the first waveguide and the second waveguide diverge from and reconverge toward one another between pairs of coupling regions of the plurality of coupling regions.

According to aspect (9), the variable ratio optical coupler of any one of aspects (1) to (8) is provided, further comprising a third waveguide arranged on or in the primary substrate, wherein a portion of the third waveguide is arranged proximate to the first waveguide in the at least one coupling region and configured for optical power transfer by evanescent coupling, and wherein the portion of the first waveguide is intermediately arranged between the portion of the second waveguide and the portion of the third waveguide in the at least one coupling region.

According to aspect (10), the variable ratio optical coupler of aspect (9) is provided, wherein the first, second, and third waveguides are formed in the primary substrate, and wherein the first waveguide is positioned at a shallower depth than the second and third waveguides relative to an upper surface of the primary substrate.

According to aspect (11), the variable ratio optical ratio coupler of any one of aspects (1) to (10), having an insertion loss of less than 1 dB.

According to aspect (12), the variable ratio optical ratio coupler of any one of aspects (1) to (11), having largest dimensions of no greater than 20 mm×10 mm×2 mm.

According to aspect (13), the variable ratio optical ratio coupler of any one of aspects (1) to (12) is provided, wherein, after a desired degree of transition between a crystalline state and an amorphous state of phase change material is attained, the degree of transition of state of the phase change material is maintained with zero static power input.

According to aspect (14), a kit is provided. The kit comprise: the variable ratio optical coupler of any one of aspects (1) to (13) and a tuning device comprising a circuit configured to deliver electrical pulses to at least one electrode segment of the plurality of electrode segments to heat the at least one electrode segment to permit adjustment of a degree of transition between a crystalline state and an amorphous state of the phase change material.

According to aspect (15), a variable ratio optical coupler is provided. The variable ratio optical couple comprises: a plurality of waveguides including first, second, and third waveguides arranged in or on a primary substrate, wherein a portion of the second waveguide is arranged proximate to the first waveguide at a first coupling region, and a portion of the third waveguide is arranged proximate to the first waveguide at a second coupling region; phase change material arranged over the first waveguide at the first coupling region and arranged over the first waveguide at the second coupling region; a first electrode segment arranged over the phase change material at a first overlap region overlying the first coupling region, the first electrode segment being arranged to receive an electrical signal configured to heat the first electrode segment to permit adjustment of a degree of transition between a crystalline state and an amorphous state of the phase change material at the first coupling region; and a second electrode segment arranged over the phase change material at a second overlap region overlying the second coupling region, the second electrode segment being arranged to receive an electrical signal configured to heat the second electrode segment to permit adjustment of a degree of transition between a crystalline state and an amorphous state of the phase change material at the second coupling region.

According to aspect (16), the variable ratio optical coupler of aspect (15) is provided, wherein the phase change material is arranged in a continuous phase change material segment extending across and between the first coupling region and the second coupling region.

According to aspect (17), the variable ratio optical coupler of aspect (15) is provided, wherein the phase change material is discontinuous between the first coupling region and the second coupling region.

According to aspect (18), the variable ratio optical coupler of any one of aspects (15) to (17) is provided, further comprising a fourth waveguide arranged in or on the primary substrate, wherein a portion of the fourth waveguide is arranged proximate to the first waveguide at a third coupling region; wherein phase change material is arranged over the first waveguide at the third coupling region; and wherein the variable ratio optical coupler further comprises a third electrode segment arranged over the phase change material at a third overlap region overlying the third coupling region, the third electrode segment being arranged to receive an electrical signal configured to heat the third electrode segment to permit adjustment of a degree of transition between a crystalline state and an amorphous state of the phase change material at the third coupling region.

According to aspect (19), the variable ratio optical coupler of any one of aspects (15) to (18) is provided, further comprising a plurality of electrically conductive traces deposited on the substrate and conductively coupled with the first electrode segment and the second electrode segment.

According to aspect (20), the variable ratio optical coupler of any one of aspects (15) to (19) is provided, wherein the primary substrate comprises a glass or glass-based material, and each waveguide of the plurality of waveguides comprises an ion exchange (IOX) waveguide arranged in the primary substrate.

According to aspect (21), the variable ratio optical coupler of any one of aspects (15) to (19) is provided, wherein the primary substrate comprises any of: a silicon nitride substrate, a silicon-on-insulator substrate, and a planar lightwave circuit substrate.

According to aspect (22), the variable ratio optical coupler of any one of aspects (15) to (21) is provided, wherein the phase change material comprises Ge₂Sb₂Se₄Te₁ (GSST).

According to aspect (23), the variable ratio optical coupler of any one of aspects (15) to (22) is provided, further comprising a secondary substrate arranged over the plurality of electrode segments, the phase change material, the first and second waveguides, and the primary substrate, wherein the secondary substrate comprises a lower index of refraction than an index of refraction of the primary substrate.

According to aspect (24), the variable ratio optical ratio coupler of any one of aspects (15) to (23), having an insertion loss of less than 1 dB.

According to aspect (25), the variable ratio optical ratio coupler of any one of aspects (15) to (24), having largest dimensions of no greater than 20 mm×10 mm×2 mm.

According to aspect (26), the variable ratio optical ratio coupler of any one of aspects (15) to (25) is provided, wherein, after a desired degree of transition between a crystalline state and an amorphous state of phase change material is attained, the degree of transition of state of the phase change material is maintained with zero static power input.

According to aspect (27), a kit is provided. The kit comprises the variable ratio optical coupler of any one of aspects (15) to (26) and a tuning device comprising a circuit configured to deliver electrical pulses to at least one electrode segment of the first electrode segment and the second electrode segment to heat the at least one electrode segment to permit adjustment of a degree of transition between a crystalline state and an amorphous state of the phase change material.

Those skilled in the art will appreciate that other modifications and variations can be made without departing from the spirit or scope of the invention.

Since modifications, combinations, sub-combinations, and variations of the disclosed embodiments incorporating the spirit and substance of the invention may occur to persons skilled in the art, the invention should be construed to include everything within the scope of the appended claims and their equivalents. The claims as set forth below are incorporated into and constitute part of this detailed description.

1. A variable ratio optical coupler comprising:
first and second waveguides arranged in or on a primary substrate, portion of the first waveguide and a portion of the second waveguide arranged proximate to one another in at least one coupling region and configured for optical power transfer by evanescent coupling;
a continuous phase change material segment arranged over the portion of the first waveguide in the at least one coupling region;
a plurality of electrode segments sequentially arranged over the continuous phase change material segment at a plurality of overlap regions; and
wherein each electrode segment of the plurality of electrode segments is arranged over a corresponding overlap region of the plurality of overlap regions, and each electrode segment is arranged to receive electrical pulses configured to heat the electrode segment to permit adjustment of a degree of transition between a crystalline state and an amorphous state of phase change material of the continuous phase change material segment at the corresponding overlap region.

2. The variable ratio optical coupler of claim 1, further comprising a plurality of electrically conductive traces deposited on the primary substrate and conductively coupled with the plurality of electrode segments.

3. The variable ratio optical coupler of claim 1, wherein the primary substrate comprises a glass or glass-based material, and each of the first waveguide and the second waveguide comprises an ion exchanged (IOX) waveguide arranged in the primary substrate.

4. The variable ratio optical coupler of claim 1, wherein the primary substrate comprises any of: a silicon nitride substrate, a silicon-on-insulator substrate, or a planar lightwave circuit substrate.

5. The variable ratio optical coupler of claim 1, wherein the continuous phase change material segment comprises Ge₂Sb₂Se₄Te₁ (GSST).

6. The variable ratio optical coupler of claim 1, wherein the continuous phase change material segment comprises a first end with a first tapered width and second end with a second tapered width.

7. The variable ratio optical coupler of claim 1, further comprising a secondary substrate arranged over the plurality of electrode segments, the continuous phase change material segment, the first and second waveguides, and the primary substrate, and the secondary substrate comprises a lower index of refraction than an index of refraction of the primary substrate.

8. The variable ratio optical coupler of claim 1, wherein the at least one coupling region comprises a plurality of coupling regions, and the first waveguide and the second waveguide diverge from and reconverge toward one another between pairs of coupling regions of the plurality of coupling regions.

9. The variable ratio optical coupler of claim 1, further comprising a third waveguide arranged on or in the primary substrate, a portion of the third waveguide arranged proximate to the first waveguide in the at least one coupling region and configured for optical power transfer by evanescent coupling, and the portion of the first waveguide intermediately arranged between the portion of the second waveguide and the portion of the third waveguide in the at least one coupling region.

10. The variable ratio optical coupler of claim 9, wherein the first, second, and third waveguides are formed in the primary substrate, and the first waveguide is positioned at a shallower depth than the second and third waveguides relative to an upper surface of the primary substrate.

11. The variable ratio optical ratio coupler of claim 1, wherein an insertion loss of the variable ratio optical ratio coupler is less than 1 dB.

12. The variable ratio optical coupler of claim 1, wherein largest dimension of the variable ratio optical coupler is no greater than 20 mm×10 mm×2 mm.

13. The variable ratio optical coupler of claim 1, wherein, after a desired degree of transition between a crystalline state and an amorphous state of phase change material is attained, the degree of transition of a state of the phase change material is maintained with zero static power input.

14. A kit comprising the variable ratio optical coupler of claim 1 and a tuning device comprising a circuit configured to deliver electrical pulses to at least one electrode segment of the plurality of electrode segments to heat the at least one electrode segment to permit adjustment of a degree of transition between a crystalline state and an amorphous state of the phase change material.

15. A variable ratio optical coupler comprising:
a plurality of waveguides including first, second, and third waveguides arranged in or on a primary substrate, a portion of the second waveguide is arranged proximate to the first waveguide at a first coupling region, and a portion of the third waveguide is-arranged proximate to the first waveguide at a second coupling region;
phase change material arranged over the first waveguide at the first coupling region and arranged over the first waveguide at the second coupling region;
a first electrode segment arranged over the phase change material at a first overlap region overlying the first coupling region, the first electrode segment being arranged to receive an electrical signal configured to heat the first electrode segment to permit adjustment of a degree of transition between a crystalline state and an amorphous state of the phase change material at the first coupling region; and
a second electrode segment arranged over the phase change material at a second overlap region overlying the second coupling region, the second electrode segment arranged to receive an electrical signal configured to heat the second electrode segment to permit adjustment of a degree of transition between a crystalline state and an amorphous state of the phase change material at the second coupling region.

16. The variable ratio optical coupler of claim 15, wherein the phase change material is arranged in a continuous phase change material segment extending across and between the first coupling region and the second coupling region.

17. The variable ratio optical coupler of claim 15, wherein the phase change material is discontinuous between the first coupling region and the second coupling region.

18. The variable ratio optical coupler of claim 15, further comprising a fourth waveguide arranged in or on the primary substrate, portion of the fourth waveguide is arranged proximate to the first waveguide at a third coupling region;
wherein phase change material is arranged over the first waveguide at the third coupling region; and
wherein the variable ratio optical coupler further comprises a third electrode segment arranged over the phase change material at a third overlap region overlying the third coupling region, the third electrode segment being-arranged to receive an electrical signal configured to heat the third electrode segment to permit adjustment of a degree of transition between a crystalline state and an amorphous state of the phase change material at the third coupling region.

19. The variable ratio optical coupler of claim 15, further comprising a plurality of electrically conductive traces deposited on the substrate and conductively coupled with the first electrode segment and the second electrode segment.

20. The variable ratio optical coupler of claim 15, wherein the primary substrate comprises a glass or glass-based material, and each waveguide of the plurality of waveguides comprises an ion exchange (IOX) waveguide arranged in the primary substrate.

21. The variable ratio optical coupler of claim 15, wherein the primary substrate comprises any of: a silicon nitride substrate, a silicon-on-insulator substrate, or a planar lightwave circuit substrate.

22. The variable ratio optical coupler of claim 15, wherein the phase change material comprises Ge₂Sb₂Se₄Te₁ (GSST).

23. The variable ratio optical coupler of claim 15, further comprising a secondary substrate arranged over the plurality of electrode segments, the phase change material, the first and second waveguides, and the primary substrate, the secondary substrate comprising a lower index of refraction than an index of refraction of the primary substrate.

24. The variable ratio optical coupler of claim 15, wherein an insertion loss of the variable ratio optical coupler is less than 1 dB.

25. The variable ratio optical coupler of claim 15, wherein a largest dimension of the variable ratio optical coupler is no greater than 20 mm×10 mm×2 mm.

26. The variable ratio optical coupler of claim 15, wherein, after a desired degree of transition between a crystalline state and an amorphous state of phase change material is attained, the degree of transition of a state of the phase change material is maintained with zero static power input.

27. A kit comprising the variable ratio optical coupler of claim 15 and a tuning device comprising a circuit configured to deliver electrical pulses to at least one electrode segment of the first electrode segment and the second electrode segment to heat the at least one electrode segment to permit adjustment of a degree of transition between a crystalline state and an amorphous state of the phase change material.
